(19) United States
(12) Patent Application Publication
(10) Pub. No.: US 2012/0063973 A1
(43) Pub. Date: Mar. 15, 2012

(54) Flexible Fluid Storage and Warming Bag and a Fluid Storage and Warming System

(75) Inventors: Gim Ching Jenny Ang, Singapore (SG); Joo Chuan Yeo, Singapore (SG); Chee Wai Albert Lu, Singapore (SG); Chee Wai Patrick Shi, Singapore (SG)

(73) Assignee: Agency for Science, Technology and Research, Connexis (SG)

(21) Appl. No.: 13/320,807

(22) PCT Filed: May 21, 2010
(86) PCT No.: PCT/SG2010/000192

§ 371 Date: Nov. 16, 2011

(30) Foreign Application Priority Data
May 22, 2009 (SG) 200903498-4

(51) Int. Cl. A61J 1/10

(52) U.S. Cl. 422/555

(57) ABSTRACT

In an embodiment, a flexible fluid storage and warming bag may be provided. The flexible fluid storage and warming bag may include two flexible main walls, each including a surrounding edge, the two flexible main walls overlapping each other and being fluid-tightly sealed together along the surrounding edges thereof, the bag including a single non-partitioned fluid chamber defined by and between the two flexible main walls and by the sealed surrounding edges; at least one fluid transfer port extending into the single non-partitioned fluid chamber and being configured to allow transfer of the fluid into and out of the bag; and an electrical heating element integrated with at least one of the two flexible main walls of the bag. A fluid storage and warming system may also be provided.

### CROSS-REFERENCE TO RELATED APPLICATION

This application claims the benefit of priority of Singapore patent application no. 200903498-4 filed 22 May 2009, the contents of which is hereby incorporated by reference in its entirety for all purposes.

### TECHNICAL FIELD

Embodiments relate to a flexible fluid storage and warming bag and a fluid storage and warming system.

### BACKGROUND

In general, blood or other fluids to be introduced into a patient may be stored in a bag under refrigeration and must be warmed before infusion. Warming is necessary so as to minimize adverse thermal reactions to the patient.

A number of warming systems or methods for warming the blood or other fluids stored in the bag prior to introduction into the patient are known. As an example, blood or other fluids stored in the bag may be warmed by immersing the bag in a warm water bath. By completely surrounding the bag in the warm water bath at a desired temperature and agitating the bag periodically, the bag containing the blood or other fluids may be brought to the desired temperature. However, adopting the water bath method may present a number of problems. Firstly, immersing the bag in a non-sterile water bath may contaminate the bag ports, such that the thawed blood or other fluids may be tainted as the thawed blood or other fluids are withdrawn from the bag. Further, immersing the bag in the water bath may cause any labels affixed to the bag to become detached. Even if the labels remain attached to the bag, the water bath often causes the labels to become wrinkled, such that it may be difficult to scan a bar code which may be imprinted on the label. In addition, any interruption in the integrity of the bag may permit an exchange of the blood and other fluids in the bag and the water in the water bath, thereby causing contamination of the blood and other fluids in the bag and the water in the water bath.

As a further example, an external warming device may be relied to heat up the blood or other fluids inside the bag in order to bring the temperature of the blood or other fluids stored in the bag to a normothermic temperature before infusing into the patient's body. However, the external warming device may be cumbersome to use and are usually not portable.

Therefore, there is a need to provide an alternative warming device or system which may overcome or at least alleviate some of the above-mentioned problems.

### SUMMARY

Various embodiments provide a flexible fluid storage and warming bag and a fluid storage and warming system which may provide efficient heating and be used at different transfusion rates. Further, the flexible fluid storage and warming bag and the fluid storage and warming system may be portable, may help to reduce contamination and may be cost-efficient.

In various embodiments, a flexible fluid storage and warming bag may be provided. The flexible fluid storage and warming bag may include two flexible main walls, each including a surrounding edge, the two flexible main walls overlapping each other and being fluid-tightly sealed together along the surrounding edges thereof, the bag including a single non-partitioned fluid chamber defined by and between the two flexible main walls and by the sealed surrounding edges; at least one fluid transfer port extending into the single non-partitioned fluid chamber and being configured to allow transfer of the fluid into and out of the bag; and an electrical heating element integrated with at least one of the two flexible main walls of the bag.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of various embodiments. In the following description, various embodiments of the invention are described with reference to the following drawings, in which:

FIG. 1 shows a perspective view of a flexible fluid storage and warming bag including an electrical heating element printed on one flexible main wall of the bag according to an embodiment;

FIG. 2A shows a perspective view of a flexible fluid storage and warming bag including an electrical heating layer arrangement releasably attached to an exterior surface of one flexible main wall of the bag according to an embodiment; FIG. 2B shows a front view of the flexible fluid storage and warming bag as shown in FIG. 2A according to an embodiment;

FIG. 3A shows a front view of an electrical heating layer arrangement including an electrically conductive strip according to an embodiment; FIG. 3B shows a perspective view of the electrical heating layer arrangement as shown in FIG. 3A according to an embodiment;

FIG. 4 shows a front view of an electrical heating layer arrangement including a plurality of electrically conductive strips according to an embodiment;

FIG. 5A shows a front view of a flexible fluid storage and warming bag including an electrical heating layer arrangement releasably attached to an exterior surface of one flexible main wall of the bag according to an embodiment; FIG. 5B shows an exploded view of the flexible fluid storage and warming bag as shown in FIG. 5A according to an embodiment;

FIG. 6A shows a side view of a flexible fluid storage and warming bag including an electrical heating element integrated with one flexible main wall of the bag according to an embodiment; FIG. 6B shows a side view of a flexible fluid storage and warming bag including an electrical heating element integrated with one of the two flexible main walls and a further electrical heating element integrated with the other of the two flexible main walls according to an embodiment;

FIG. 7A shows a front view of a fluid storage and warming system including a flexible fluid storage and warming bag and a hanger and power supply device, wherein the hanger and power supply device is electrically coupled to an electrical heating element of the flexible fluid storage and warming bag via a pair of hangers and power supply contacts according to an embodiment; FIG. 7B shows a front view of a fluid storage and warming system including a flexible fluid storage and warming bag and a hanger and power supply device, wherein the hanger and power supply device is electrically coupled to an electrical heating element of the flexible fluid storage and warming bag via an electrical wire according to an embodiment;

FIG. 8A shows a front view of a flexible fluid storage and warming bag including an electrical heating element with a first design integrated with one of the two flexible main walls of the bag according to an embodiment; FIG. 8B shows a front view of a flexible fluid storage and warming bag including an electrical heating element with a second design integrated with one of the two flexible main walls of the bag according to an embodiment; FIG. 8C shows a front view of a flexible fluid storage and warming bag including an electrical heating element with a third design integrated with one of the two flexible main walls of the bag according to an embodiment; FIG. 8D shows a front view of a flexible fluid storage and warming bag including an electrical heating element with a fourth design integrated with one of the two flexible main walls of the bag according to an embodiment;

FIG. 9A shows an open-up view of a flexible fluid storage and warming bag, including an electrical heating element integrated with one of the two flexible main walls and a further electrical heating element integrated with the other of the two flexible main walls with at least substantially complementary designs according to an embodiment; FIG. 9B shows an overlapping view of the flexible fluid storage and warming bag as shown in FIG. 9A according to an embodiment;

FIGS. 10A to 10F show respective electrical heating layer arrangements including different layers attached on a flexible fluid storage and warming bag according to an embodiment;

FIG. 11 shows a block diagram of a fluid storage and warming system including a flexible fluid storage and warming bag and a hanger and power supply device according to an embodiment;

FIG. 12A shows a fluid storage and warming system including an electrical heating layer arrangement and a hanger and power supply device according to an embodiment; FIG. 12B shows a fluid storage and warming system including a flexible fluid storage and warming bag and a hanger and power supply device according to an embodiment;

FIG. 13A shows the fluid storage and warming system of FIG. 7B in use on a patient according to an embodiment; FIG. 13B shows the fluid storage and warming system of FIG. 7A in use on a patient according to an embodiment;

FIG. 14A shows a left side view of the fluid storage and warming system including a flexible fluid storage and warming bag and a hanger and power supply device, wherein the hanger and power supply device is electrically coupled to an electrical heating element of the flexible fluid storage and warming bag via a pair of hangers and power supply contacts according to an embodiment; FIG. 14B shows a front view of the fluid storage and warming system as shown in FIG. 14A according to an embodiment; FIG. 14C shows a right side view of the fluid storage and warming system as shown in FIG. 14A according to an embodiment; FIG. 14D shows a rear view of the fluid storage and warming system as shown in FIG. 14A according to an embodiment;

FIG. 15A shows an internal view of the hanger and power supply device as shown in FIGS. 14A to 14D according to an embodiment; FIG. 15B shows a front open-up view of the hanger and power supply device as shown in FIGS. 14A to 14D according to an embodiment;

FIG. 16A shows a front view of the fluid storage and warming system including a flexible fluid storage and warming bag and a hanger and power supply device, wherein the hanger and power supply device is electrically coupled to an electrical heating element of the flexible fluid storage and warming bag via an electrical wire according to an embodiment; FIG. 16B shows a side view of the fluid storage and warming system as shown in FIG. 16A according to an embodiment; FIG. 16C shows a rear side view of the fluid storage and warming system as shown in FIG. 16A according to an embodiment;

FIG. 17A show a front view of a pair of hangers of a flexible fluid storage and warming bag according to an embodiment; FIG. 17B show a side view of the pair of hangers as shown in FIG. 17A according to an embodiment; FIG. 17C show a top view of the pair of hangers as shown in FIG. 17A according to an embodiment;

FIG. 18A show a front view of a pair of power supply contacts of a hanger and power supply device according to an embodiment; FIG. 18B show a side view of the pair of power supply contacts as shown in FIG. 18A according to an embodiment; FIG. 18C show a top view of the pair of power supply contacts as shown in FIG. 18A according to an embodiment; and

FIG. 19A shows a perspective view of an electrical heating layer arrangement configured to coil around a tubing according to an embodiment; FIG. 19B shows a perspective view of an electrical layer arrangement configured to twirl around a tubing according to an embodiment.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

An embodiment may provide for a flexible fluid storage and warming bag. The flexible fluid storage and warming bag may include two flexible main walls, each including a surrounding edge, the two flexible main walls overlapping each other and being fluid-tightly sealed together along the surrounding edges thereof, the bag including a single non-partitioned fluid chamber defined by and between the two flexible main walls and by the sealed surrounding edges; at least one fluid transfer port extending into the single non-partitioned fluid chamber and being configured to allow transfer of the fluid into and out of the bag; and an electrical heating element integrated with at least one of the two flexible main walls of the bag.

In an embodiment, the flexible fluid storage and warming bag may be a bag for storing blood, for example, a so-called blood bag. The bag may also be used for storing any other fluids, for example, saline solution, dialysis solution, bone marrow or any other suitable bodily fluids. The fluid may be stored in a liquid state or in a solid state (for example frozen blood) in the bag.

In an embodiment, the number of the fluid transfer ports extending into the single non-partitioned fluid chamber may vary depending on user and design requirements. For example, the bag may include only one fluid transfer port configured to allow transfer of the fluid into and out of the bag through the same fluid transfer port. As another example, the bag may include two fluid transfer ports, one fluid transfer port for transfer of fluid into the bag and the other fluid transfer port for transfer of fluid out of the bag. As a further example, the bag may include three fluid transfer ports, the third fluid transfer port configured for connecting to another bag to prevent interruption to the transfer of fluid out of the respective bags to the patient, for example during blood transfusion when it may be required to transfuse more than one bag of blood.

In an embodiment, each fluid transfer port may be open-ended or may be sealed from the external environment by a capping portion until prior to use so as to prevent contamination.

In an embodiment, one or more tubings may be connected to the blood bag. Each tubing may be connected to a respective fluid transfer port. Each tubing may be formed as an integral part of the blood bag or may be formed as a separate item from the blood bag. The tubing may be used for blood infusion, blood transfer or blood transfusion. Each tubing may include an intravenous (IV) tubing for example.

In an embodiment, the flexible fluid storage and warming bag may further include a further electrical heating element; wherein the electrical heating element may be integrated with one of the two flexible main walls of the bag and the further electrical heating element may be integrated with the other of the two flexible main walls of the bag. The flexible fluid storage and warming bag may further include any suitable number of electrical heating elements and further electrical heating elements depending on number of flexible main walls of the bag and also depending on user and design requirements.

In an embodiment, each electrical heating element may include a wire of a conductive material that generates resistance, when electrical current passes through it, and generates therefore heat, or a thermal conductive element disposed on the exterior surface of the bag. Alternatively, each electrical heating element may include an electrical heating layer arrangement attached to an exterior surface of the respective one of the two flexible main walls of the bag. The wire or thermal conductive element or the electrical heating layer arrangement may be configured to be flexible and made conformable to any fluid bag surface so as to provide a flexible heating interface and an efficient heat transfer to the fluid stored in the bag.

In an embodiment, each of the electrical heating element and the further electrical heating element may further be configured to coil around a tubing or may further be configured to twirl around the tubing so as to warm the blood flowing through the tubing to the patient. The electrical heating element and the further electrical heating element positioned on the tubing may be independent of or in addition to that already present on the bag so as to provide an increased and faster warming of the blood.

In an embodiment, the electrical heating layer arrangement may be releasably attached to the exterior surface. The releaseable attachment may be via an adhesive layer or any other suitable means which allow temporary attachment and detachment of the electrical heating layer arrangement. The releaseable attachment allows the electrical heating layer arrangement to be used on a bag and when the bag is to be disposed, the electrical heating layer arrangement may be detached and attached on a new bag. The electrical heating layer arrangement may be re-used on the bag for as many suitable numbers of times depending on user and design requirements.

In an embodiment, the electrical heating layer arrangement may be attached to the exterior surface by a technique selected from a group consisting of printing, embossing, heat sealing, sonic sealing, adhesion, lithographic and a combination thereof.

In an embodiment, the electrical heating layer arrangement may overlie at least substantially the entire exterior surface. Alternatively, the electrical heating layer arrangement may overlie at different positions on the exterior surface. The extent of overlap between the electrical heating layer arrangement and the exterior surface of the bag is designed in accordance with the amount of fluid housed within the bag and the rate at which the fluid needs to be warmed.

In an embodiment, the electrical heating layer arrangement may include a layer of an electrically conductive strip extending in for example a meander design, a serpentine design or a spiral design on the exterior surface. The electrically conductive strip may include any suitable design as long as the electrically conductive strip can generate sufficient heat to evenly warm up the fluid stored inside the bag in liquid or frozen state. The electrically conductive strip may also be arranged in any other suitable pattern on the exterior surface of the bag, for example, in a rectangle, a circle or a square design. Each electrically conductive strip may be arranged in series, in parallel, or in a combination of both series and parallel depending on user and design requirements.

In an embodiment, the further electrical heating element may include a further electrical heating layer arrangement attached to a further exterior surface of the other of the two flexible main walls of the bag.

In an embodiment, the layer of the electrically conductive strip attached to the exterior surface of the one of the two flexible main walls and the layer of the electrically conductive strip attached to the exterior surface of the other flexible main wall may be of at least substantially complementary designs resulting in that the two layers of the electrically conductive strip cover at least substantially the entire overlapping area of the two flexible main walls. Accordingly, the electrically conductive strip may be configured such that a large overlapping area may be covered when the two flexible main walls overlap with each other.

In an embodiment, the electrically conductive strip may be printed or embossed directly onto the exterior surface of the bag. The electrically conductive strip also be disposed on the exterior surface by lithography.

In an embodiment, the layer of the electrically conductive strip may be designed such that a surface ratio between the exterior surface of either one of the two flexible main walls and a total surface of the layer of the electrically conductive strip attached to the exterior surface of that one of the two flexible main walls may be between 3:1 and 1:1, preferably 1.5:1. The dimension of the total surface of the layer of the electrically conductive strip may be related to the time taken for the stored blood to be warmed. The smaller is the total surface of the layer of the electrically conductive strip in contact with the exterior surface, the longer it takes for the stored blood to be warmed.

In an embodiment, the layer of the electrically conductive strip may include a material selected from the group consisting of silver-based conductive ink, copper-based conductive ink, conductive polymer ink, and carbon-based resistive ink for example.

In an embodiment, the electrical heating layer arrangement may further include an adhesive layer arranged between the exterior surface of the flexible main wall of the bag and the layer of the electrically conductive strip. The layer of the electrically conductive strip may first be disposed on the adhesive layer before the electrical heating layer arrangement is brought to be in contact with the exterior surface.

In this embodiment, the electrical heating layer arrangement may further include a thermal diffusion layer arranged between the exterior surface of the flexible main wall of the bag and the layer of the electrically conductive strip.

In an embodiment, the electrical heating layer arrangement may further include a thermal diffusion layer arranged on the layer of the electrically conductive strip and an adhesive layer arranged between the exterior surface of the flexible main wall of the bag and the thermal diffusion layer. The thermal diffusion layer may provide a thermally efficient path from the electrically conductive strip to the bag to be heated. Further, the thermal diffusion layer may provide a substantially uniform thermal heating over the surface area of the flexible main wall of the bag.

In an embodiment, the adhesive layer may include a material selected from a group consisting of heat curing adhesive layers, UV curing adhesive layers, and pressure sensitive adhesive layers, for example.

In an embodiment, the thermal diffusion layer may include a material selected from a group consisting of a thermally conductive epoxy, a thermally conductive adhesive, and a thermally conductive resin.

In an embodiment, the electrical heating layer arrangement may further include a thermal insulation layer arranged on a side of the layer of the electrically conductive strip being remote from the exterior surface of the main wall of the bag to which the electrical heating layer arrangement is attached.

In an embodiment, the thermal diffusion layer is to ensure good temperature uniformity. The thermal insulation layer is to minimize thermal leakage to the environment and to improve heating rate. The electrical insulation layer is to prevent electrical short circuit.

In an embodiment, the thermal insulation layer may include a material selected from a group consisting of a thermally insulating epoxy, a thermally insulating adhesive, and a thermally insulating resin, for example.

In an embodiment, the electrical heating layer arrangement may include a thermal insulation layer and electrical insulation layer arranged in contact with the layer of the electrically conductive strip and the exterior surface.

In an embodiment, the thermal insulation and electrical insulation layer comprises a material selected from a group consisting of a thermally insulative epoxy, a thermally insulative adhesive, and a thermally insulative resin.

In an embodiment, the electrical heating layer arrangement may include a thermal conduction and electrical insulation layer arranged in contact with the exterior surface and the layer of the electrically conductive strip.

In an embodiment, the thermal conduction and electrical insulation layer may include a material selected from a group consisting of a thermally conductive epoxy, a thermally conductive adhesive, and a thermally conductive resin for example.

In an embodiment, the electrical heating layer arrangement may further include a base layer arranged on a side of the layer of the electrically conductive strip being remote from the exterior surface of the main wall of the bag to which the electrical heating layer arrangement is attached.

In an embodiment, the base layer may include a material selected from a group consisting of a polyethylene terephthalate (PET) substrate and a polyethylene naphthalate (PEN) substrate, for example. The base layer may be of a relatively rigid material so as to act as a base for subsequent deposition of materials.

In an embodiment, the base layer may act as a starting layer for subsequent deposition of the thermal insulating layer, the layer of the electrically conductive strip, the thermal diffusion layer and the adhesive layer before the electrical heating layer arrangement is brought into contact with the exterior surface of the main wall of the bag.

In an embodiment, the base layer may be removed after the electrical heating layer arrangement is brought into contact with the exterior surface or the base layer may remain as an exterior layer of the electrical heating layer arrangement so as to prevent direct exposure of the thermal insulating layer or the layer of electrically conductive strip to the user.

In an embodiment, each of the two flexible main walls may include a fluid impermeable material. Each of the two flexible main walls may also include a flexible material which may accommodate the fluid stored within the chamber of the bag. The selection of the material for each of the two flexible main walls may vary depending on the contents of the fluid stored within the bag. For example, each of the two flexible main walls may include a material with a melting temperature at least higher than the maximum temperature of the heating element such that the flexible main wall does not melt when the warming process is being carried out.

In an embodiment, each of the two flexible main walls may include a material selected from a group consisting of DEHP-plasticized PVC, polyolefin, and polyethylene-co-vinyl acetate (EVA), for example.

In an embodiment, the flexible fluid storage and warming bag may further include two longitudinal sides and two transverse sides along the surrounding edges of the two flexible main walls; wherein the layer of electrically conductive strip includes two end portions being arranged proximate to one of the two transverse sides of the bag. The two end portions may also be arranged directly at or along any one of the two transverse sides of the bag. Alternatively, the two end portions may also be arranged proximate to or directly at any one of the two longitudinal sides of the bag. The position of the two end portions may vary depending on the subsequent ease of connection to a hanger and power supply device. The position of the two end portions may also vary depending on user and design requirements. As an example, a blood bag is typically of a substantially rectangular shape. By longitudinal sides, we mean the side of the main wall which is generally longer than the other side. And by transverse sides, we mean the side of the main wall which is generally shorter. In this case, the longitudinal side is substantially perpendicular to the transverse side. If the blood bag is of a square shape, then the transverse side may have the same dimension as the longitudinal side.

In an embodiment, on the positioning of the fluid transfer port, if there are more than one fluid transfer port, the fluid transfer ports may all be arranged adjacent to each other along either one of the two longitudinal sides or two transverse sides or may be respectively arranged at different longitudinal sides or transverse sides depending on user and design requirements.

As an example, if the bag is generally hanged in a generally upright position at one transverse side thereof, then the fluid transfer ports are generally arranged in the other opposite transverse side so as to allow the fluid to flow easily out of the bag due to gravitational forces.

In an embodiment, both end portions of the electrically conductive strip may be designed to include a larger width than that of the electrically conductive strip and to be contacted to an external power supply. The larger width may allow easy connection with the external power supply.

In an embodiment, the flexible fluid storage and warming bag may further include a pair of hangers for hanging the bag on a hanger and power supply device, wherein each of the pair of hangers is of an electrically conductive material and attached to a respective one of the two end portions of the electrically conductive strip so as to be electrically connected thereto.

In an embodiment, each of the pair of hangers may be adapted to be mechanically engaged with and electrically coupled to the hanger and power supply device.

In an embodiment, the electrical heating element or the electrical heating layer arrangement may include a thickness (t) of about 10 um to about 80 um, preferably about 20 um to about 70 um for example. The electrical heating element or the electrical heating layer arrangement may include a width (W_{electrical heating element}) of about 100 to 2000 um, preferably about 500 um to about 2000 um for example. The electrical heating element or the electrical heating layer arrangement may also include a length (referring to the length from the start of one terminal end (or end portion) to the other terminal end (or end portion)) of about 1000 mm to about 4000 mm, preferably about 1500 mm to about 2500 mm.

In an embodiment, the blood bag may be sized to accommodate a variety of volumes depending on user and design requirements. The blood bag may accommodate about 150 ml, about 300 ml or about 600 ml in volume. As an example, the blood bag may accommodate about 300 ml in volume.

In an embodiment, the thermal conduction and electrical insulation layer may include a thickness of about 20 um to about 100 um for example. The thermal conduction and electrical insulation layer may include a thickness of about 2 to 3 times the thickness of the electrically conductive strip.

In an embodiment, the thermal insulation layer may include a thickness of about 20 um to about 100 um for example. The thermal insulation layer may also include a thickness of about 2 to 3 times the thickness of the electrically conductive strip.

In an embodiment, the electrical heating element may include a resistance of about 0.025 Ω/cm² to about 0.15 Ω/cm², preferably about 0.05 Ω/cm² for example.

In an embodiment, the power density applied may be between about 0.1 W/cm² to about 0.3 W/cm², preferably about 0.25 W/cm² for example.

In an embodiment, power applied to the layer of the electrically conductive strip may be expressed as:

Power applied=I*I*R,

I=applied current
R=resistance (function of the total surface area of the layer of electrically conductive strip and the applied current).

In an embodiment, a fluid storage and warming system may be provided. The fluid storage and warming system may include a flexible fluid storage and warming bag according to each and any embodiments described above and a hanger and power supply device adapted to be electrically coupled to the electrical heating element of the bag to supply electrical power thereto.

In an embodiment, the fluid storage and warming system may include a flexible fluid storage and warming bag, wherein the hanger and power supply device may include two power supply contacts configured to be respectively mechanically engaged with and electrically connected to the pair of hangers.

In an embodiment, a fluid storage and warming system may be provided. The fluid storage and warming system may include a flexible fluid storage and warming bag, and a hanger and power supply device adapted to be electrically coupled to the electrical heating element of the bag to supply electrical power thereto.

In an embodiment, the hanger and power supply device may include a pair of or two power supply contacts configured to be respectively connected to the pair of hangers.

In an embodiment, the number of hangers and the power supply contacts may vary depending on user and design requirements.

In an embodiment, the hanger and power supply device may include a slot so as to accommodate a portion of the flexible fluid storage and warming bag carrying the electrical contacts of the electrical heating element.

In an embodiment, the hanger and power supply device may be electrically coupled to the electrical heating element via at least one electrical wire.

In an embodiment, the hanger and power supply device may include any suitable combination of components selected from a group consisting of a power supply, a temperature controller, a solid state relay, a display to display temperature of the fluid stored within the bag, a power supply input port, a power supply output port, a temperature sensor, and a power supply switch.

In an embodiment, the power supply may include a battery or may be directly connected to the power supply mains. For example, the power supply may be a lithium polymer battery configured to yield an overall voltage of about 12 Vdc to about 15 Vdc rated at 3 amp-hour or a normal AC-DC adapter yielding preferably about 30 W rating.

In an embodiment, a blood bag with an integrated electrical heating element on an exterior surface of the blood bag may be provided. The blood bag may be capable of heating up the fluid inside the blood bag to normothermic temperature.

In an embodiment, a flexible heating element may be printed directly onto the exterior surface of a blood bag by using conductive ink that is capable of heating up the blood inside the blood bag to normothermic temperatures when connected to a power source or power supply.

In an embodiment, the blood bag may include a flexible heater circuitry or element on either side, or both sides of the exterior surface that is capable of heating up the blood inside the blood bag to normothermic temperatures when connected directly to the power source without having to rely on an external warming device. The flexible heater element may be printed directly onto the exposed surface of the blood bag by using any printing technology such as screen printing, roll-to-roll or embossing onto either one exposed surface, or both exposed surfaces of the blood bag which may be made of, but not limited to, medical grade plasticized PVC material.

The printing material of the heater or heating element may be made of any conductive ink such as Asahi L-411AW or any other ink alloy as long as the heater or heating element is capable to produce the desired heating temperature to heat up the fluid stored in the bag.

In an embodiment, the power supply may be attached to the ends of the heating element by means of tapping the wires onto the end connection points of the heater or by slotting the printed heater blood bag into a specially designed blood bag holder which provide connectivity of the blood bag to the power supply source.

In an embodiment, the blood bag with integrated heating element may provide a portable solution in warming fluid in the blood bag. Further, it may be easy to use since no priming or complicated setup procedures may be needed.

In an embodiment, a mobile way of warming blood to normothermic temperature before physiological fluids are infused into a patient is provided. Blood is maintained at a preferred temperature of about 40° C. to protect patients from hypothermia in an operating theatre, intensive care or other environment where transfusion therapies are needed.

In an embodiment, a flexible printed heating element on the blood bag effectively heats blood substantially uniformly.

In an embodiment, a portable and lightweight fluid storage and warming system with temperature controls or controller may be provided.

In an embodiment, simple set-up procedures allow the fluid storage and warming system to be activated in a relatively fast manner, for example about 30 seconds.

In an embodiment, the fluid storage and warming system may include a hanger and power supply device and a heating sticker pasted on any state of the art blood bag.

In an embodiment, the system includes a hanger and power supply device and a fluid storage and warming bag with a printed electrical heating element.

In an embodiment, the heating device or the hanger and power supply device may be about 1 kg to about 1.5 kg. One full recharge of the battery may be able to last about 10 or 12 usages approximately. Accurate temperature indication and control may be shown on a display or screen on the heating device. The heating system or the fluid storage and warming system may be maintained at about 40° C. to prevent overheating.

In an embodiment, the flexible heating sticker may not contaminate the blood in the blood bag. The flexible heating sticker may be easy to use and is affordable.

In an embodiment, the blood bag with the printed heating element may function like a normal blood bag, with the improvement that the blood stored within the blood bag may be warmed in an efficient manner.

In an embodiment, the heating system may include a safety feature such that the heating system is self regulating with a temperature indicator. The heating system may include two parts such as the blood bag and the heating sticker and the heating sticker may be disposable.

In an embodiment, the power supply may include a DC power supply voltage and/or a battery which is chargeable for portability. The temperature sensor may be able to measure temperature range between about 0° C. to about 80° C. The solid state relay may include a relay with a control voltage between about 3 VDC to about 32 VDC and a load voltage of about 3 VDC to about 36 VDC. The current is about 3 A.

In an embodiment, the battery may include a voltage rating of between 12 V to 15 V. The battery may provide a current of about 2 A to about 3 A, a power of about 30 watts and 2.3 Ah.

In an embodiment, a hook or ring coupled to the heating device may be able to support at least about 2 kg of weight. The dimension of the heating device may be about 140 mm in length, about 77 mm in breadth and about 90 mm in height.

In an embodiment, the heating system may be used in hospitals to provide an additional choice of a blood warmer for slow to medium flow and to provide instant solutions for emergency blood transfusion in disaster area.

In an embodiment, the heating system may be used in army as the heating system may be portable to be used in field hospitals for continuous warming. Further, the heating device is able to be ruggedized for outdoor use.

In an embodiment, a blood bag with printed heater may be provided. A self-heating blood bag that is able to warm up the fluids within the bag to normothermic temperature without using the conventional methods of warm water bath may be provided. Blood is normally stored in cold temperatures from about 4° C. to about 6° C. Rapid infusion of such cold physiological fluids may cause hypothermia in patients. The heating device has provided a competitive edge in terms of its portability and ease of use.

In an embodiment, the printed heating sticker may be customized for other medical instruments such as dialysis bags, saline bags, crystalloids, infusion tubes and laboratory instruments for example.

In an embodiment, the blood bag can maintain the blood at a specific temperature during dispensing and the doctor is able to get direct access to the blood bag, visually and physically. There are no complicated set up procedures and no pressure bags or additional agitation devices are needed to get faster flow when required.

In an embodiment, the heating system may be cost competitive, relatively light, provide substantially uniform heating, allow ease of operating and no external pump may be needed.

In an embodiment, the heating system may be advantageous for cold environments or temperature or arctic or high altitude or emergency rescue conditions when the blood may be in a frozen state when being used in the open. In such a situation, it may be required to supply constant heat to the blood so as to first thaw the blood and to maintain the blood at a desired temperature thereafter.

In an embodiment, a device for warming of a physiological fluid before introduction into a patient may be provided. The device may include a flexible substrate conformable to the shape of the fluid bag, or fluid containing products; a thermal conductive ink printed on at least one side of the flexible substrate; a power source connected to the conductive ink, wherein power supplied causes the conductive ink to radiate heat; and a temperature controller coupled to the power source and the conductive ink, the temperature controller is adapted to control the voltage delivered to the conductive ink.

In an embodiment, the controller may further include at least one temperature sensor in contact with the flexible substrate.

In an embodiment, the flexible substrate may be attached to any surface of fluid bag, or fluid containing products via adhesive means.

In an embodiment, a blood bag with a flexible heater circuitry on either one side or both sides of its surface that is capable of warming or heating up the blood inside the blood bag to normothermic temperatures when connected directly to power source without having to rely on an external warming device may be provided.

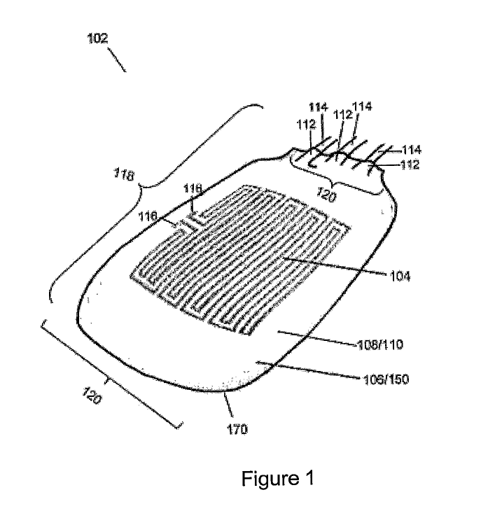

FIG. 1 shows a perspective view of a flexible fluid storage and warming bag 102 including an electrical heating element 104 printed on one flexible main wall 106 of the bag 102 according to an embodiment.

The flexible fluid storage and warming bag 102 may be a bag for storing blood, for example, a so-called blood bag. The bag 102 may also be used for storing any other fluids 108, for example, saline solution, dialysis solution, bone marrow or any other suitable bodily fluids. The fluid 108 may be stored in a liquid state or in a solid state (for example frozen blood) in the bag 102.

The flexible fluid storage and warming bag 102 may include two flexible main walls 106 (only one is shown in FIG. 1), each including a surrounding edge 170, the two flexible main walls 106 overlapping each other and being fluid-tightly sealed together along the surrounding edges 170 thereof. The bag 102 includes a single non-partitioned fluid chamber 110 defined by and between the two flexible main walls 106 and by the sealed surrounding edges 170. The bag 102 further includes three fluid transfer ports 112 extending into the single non-partitioned fluid chamber 110, each fluid transfer port 112 being configured to allow transfer of the fluid 108 into and out of the bag 102. In addition, the bag 102 includes an electrical heating element 104 printed directly on one flexible main wall 106 of the bag 102.

The three fluid transfer ports 112 may be a fluid inlet port, a fluid outlet port and a fluid transfer port or a spare port. The number of fluid transfer port 112 may vary depending on user and design requirements.

One or more tubings 114 may be connected to the blood bag 102 for transfer of blood from the bag 102 to the patient. Each tubing 114 may be connected to each fluid transfer port 112. Each tubing 114 may be formed as an integral part of the blood bag 102 or may be formed as a separate item from the blood bag 102.

Each electrical heating element 104 may be printed directly on one flexible main wall 106 of the bag 102 by printing, embossing, lithography or any other suitable techniques. The electrical heating element 104 may employ a series circuitry heating and may extend in a serpentine design on the exterior surface 150 of the one flexible main wall 106 of the bag 102. However, other designs such as a spiral design or a meander design may also be adopted. The electrical heating element 104 may include any suitable design as long as the electrical heating element 104 can generate sufficient heat to evenly warm up the fluid 108 stored inside the bag 102 in liquid or frozen state.

The flexible fluid storage and warming bag 102 as shown in FIG. 1 may be of a substantially rectangular shape and includes two longitudinal sides 118 and two transverse sides 120 along the surrounding edges 170 of the two flexible main walls 106. The electrical heating element 104 includes two end portions 116 being arranged proximate to one of the two longitudinal sides 118 of the bag 102. Further, the three fluid transfer ports 112 and three tubings 114 may be arranged at one of the two transverse sides 120 of the bag 102. The position of the two end portions 116 and the fluid transfer ports 112 or tubings 114 may vary depending on user and design requirements.

For example, the single non-partitioned fluid chamber 110 may be configured to allow fluid 108 to circulate or flow within the fluid chamber 110 without being constrained to travel along a predetermined fluid path after entering by one fluid transfer port 112 and before exiting by the same or another fluid transfer port 112. For example, the single non-partitioned fluid chamber 110 may be configured to allow the fluid 108 to circulate or flow within the fluid chamber 110 without being constrained to a predetermined fluid path that leads from one fluid transfer port 112 to another fluid transfer port 112, thus advantageously allowing thawing and fluid flow out of a fluid transfer port 112 to occur concurrently rather than sequentially. For example, the single non-partitioned fluid chamber 110 may be configured to allow the fluid 108 to circulate or flow within the fluid chamber 110 without being constrained to a predetermined fluid path corresponding to a design of the electrical heating element 104. The single non-partitioned chamber 110 does not have any fluid barriers within the bag 102, thereby preventing any predefined routing for storage of the fluid 108 within the bag 102.

For example, that the fluid transfer ports 112 may be interchangeably used such that accuracy in the orientation or position of the electrical heating element 104 in relation to the fluid transfer ports 112 is not required, presumably this is relevant for the embodiments where the electrical heating element 104 is releasably applied to the bag 102 under emergency circumstances. The electrical heating element 104 may be positioned in any suitable position on the bag 102, for example on either of the exterior surfaces 150 of the flexible main walls 106 of the bag 102 or overlapping with the sealed surrounding edges 170 of the bag 102 such that the electrical heating element 104 is in contact with both exterior surfaces 150 of the bag 102.

As an example, in the case of the embodiment involving a releasably attached heating element, the user in an emergency situation may not be able to be precise in how the user attaches the electrical heating element 104 to the bag 102. Advantageously, in the present invention it may not necessary for a certain degree of precision from the user to ensure that the electrical heating element 104 corresponds to the path of fluid flow in the bag 102.

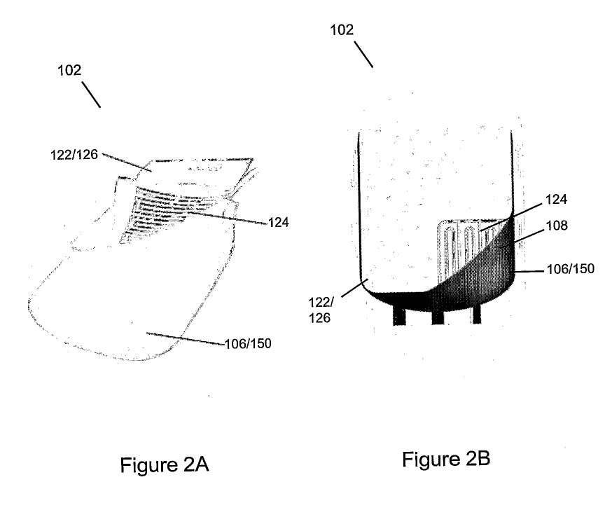

FIG. 2A shows a perspective view of a flexible fluid storage and warming bag 102 including an electrical heating layer arrangement 122 releasably attached to an exterior surface 150 of one flexible main wall 106 of the bag 102 according to an embodiment; FIG. 2B shows a front view of the flexible fluid storage and warming bag 102 as shown in FIG. 2A according to an embodiment.

In FIGS. 2A and 2B, an electrical heating layer arrangement 122 or a so called blood bag label is attached to an exterior surface 150 of one of the two flexible main walls 106 of the bag 102. The electrical heating layer arrangement 122 may be configured to be flexible and made conformable to any fluid bag surface so as to provide a flexible heating interface and an efficient heat transfer to the fluid 108 stored in the bag 102.

The electrical heating layer arrangement 122 may be releasably attached to the exterior surface 150. The releaseable attachment may be via an adhesive layer 126 or any other suitable means which may allow temporary attachment and detachment of the electrical heating layer arrangement 122.

The electrical heating layer arrangement 122 may overlie at least substantially the entire exterior surface 150 of one of the two flexible main walls 106 of the bag 102. The extent of overlay depends on the amount of fluid 108 housed within the bag 102 and the rate at which the fluid 108 needs to be warmed.

The electrical heating layer arrangement 122 may include a layer of an electrically conductive strip or circuit 124 employing a parallel circuitry heating and faces the exterior surface 150 of one of the two flexible main walls 106 of the bag 102. The electrically conductive strip 124 may include any suitable design as long as the electrically conductive strip 124 can generate distributed heat to warm up the fluid 108 stored inside the bag 102. The electrically conductive strip 124 may also be arranged in any suitable pattern, for example, in a rectangle, a circle or a square design. The number of electrically conductive strips 124 within the layer of the electrically conductive strip 124 may vary and each electrically conductive strip 124 may be arranged in series, in parallel, or in a combination of both series and parallel depending on user and design requirements.

The layer of the electrically conductive strip 124 may be designed such that a surface ratio between the exterior surface 150 of either one of the two flexible main walls 106 and a total surface of the layer of the electrically conductive strip 124 attached to the exterior surface 150 of that one of the two flexible main walls 106 may be about 1:1. Other suitable surface ratios for example 3:1 and 1.5:1 may be adopted depending on user and design requirements.

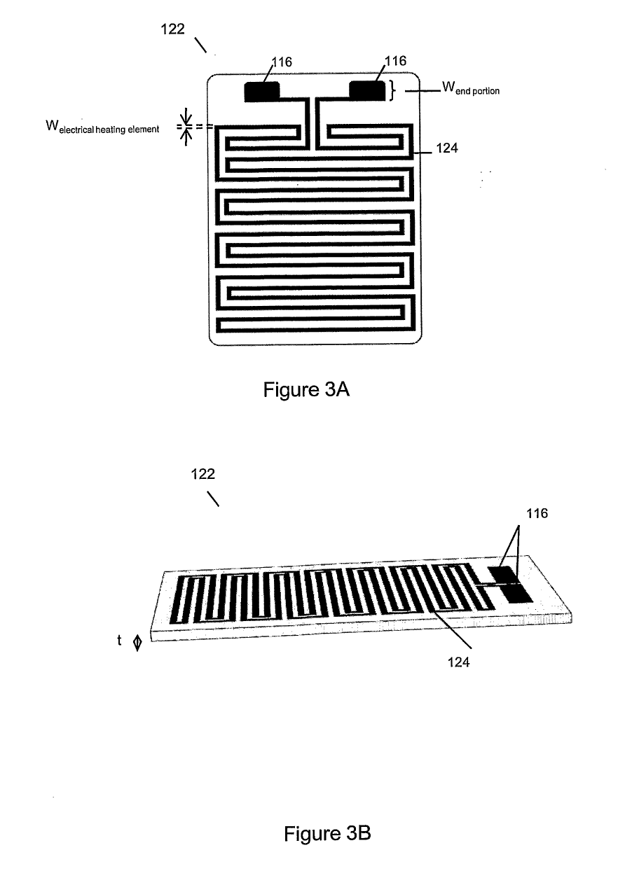

FIG. 3A shows a front view of an electrical heating layer arrangement 122 including an electrically conductive strip 124 according to an embodiment. FIG. 3B shows a perspective view of the electrical heating layer arrangement 122 as shown in FIG. 3A according to an embodiment.

The electrical heating layer arrangement 122 may include a layer of an electrically conductive strip 124 employing a series circuitry heating and extending in a serpentine design on the exterior surface (not shown) of one of the two flexible main walls (not shown) of the bag (not shown). However, the electrically conductive strip 124 may include any other suitable design such as a spiral design or a meander design as long as the electrically conductive strip 124 can generate distributed heat to warm up the fluid (not shown) stored inside the bag. The electrically conductive strip 124 may also be arranged in a substantially rectangle pattern on the exterior surface of the bag as shown in FIGS. 3A and 3B but may also be arranged in any other suitable pattern, for example, in a circle, a square or a triangle depending on user and design requirements. Further, the length of the electrically conductive strip 124 may vary depending on user and design requirements.

Each electrically conductive strip 124 includes two end portions 116. Each end portion 116 may be designed to be connected to an external power supply (not shown). Each end portion 116 may include a larger width (W_{end portion}) than the width (W_{electrical heating element}) of the electrically conductive strip 124. The larger width may allow an ease of connection of the end portions 116 with the external power supply.

The electrical heating layer arrangement 122 may include a thickness (t) of about 10 um to about 80 um, preferably about 20 um to about 70 um for example. The electrically conductive strip 124 may include a width (W_{electrical heating element}) of about 100 to about 2000 um, preferably about 500 um to about 2000 um for example. The electrically conductive strip 124 may also include a length (referring to the length from the start of one end portion 116 to the other end portion 116) of about 1000 mm to about 4000 mm, preferably about 1500 mm to about 2500 mm.

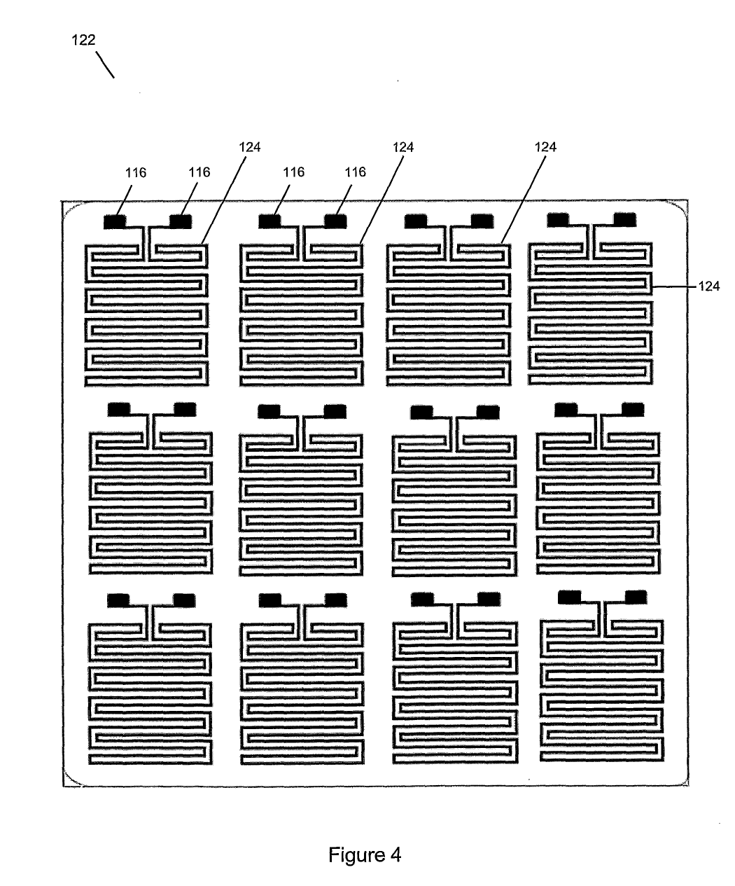

FIG. 4 shows a front view of an electrical heating layer arrangement 122 including a plurality of electrically conductive strips 124 according to an embodiment.

FIG. 4 shows that the electrical heating layer arrangement 122 includes a plurality of electrically conductive strips 124, for example 12, the electrically conductive strips 124 arranged adjacent to each other. However, the electrical heating layer arrangement 122 may include any suitable number of electrically conductive strip 124. Each electrically conductive strip 124 may employ a series circuitry heating and may extend in a serpentine design on the exterior surface (not shown) of one of the two flexible main walls (not shown) of the bag (not shown). Each conductive strip 124 may extend in a same design or a different design depending on user and design requirements. Further, each electrically conductive strip 124 includes two end portions 116.

The electrical heating layer arrangement 122 including the plurality of electrically conductive strips 124 as shown in FIG. 4 may be attached to the exterior surface of one of the two flexible main walls of the bag or may be separated into an individual electrically conductive strip 124 as shown in FIGS. 3A and 3B before being attached to the exterior surface of one of the two flexible main walls of the bag.

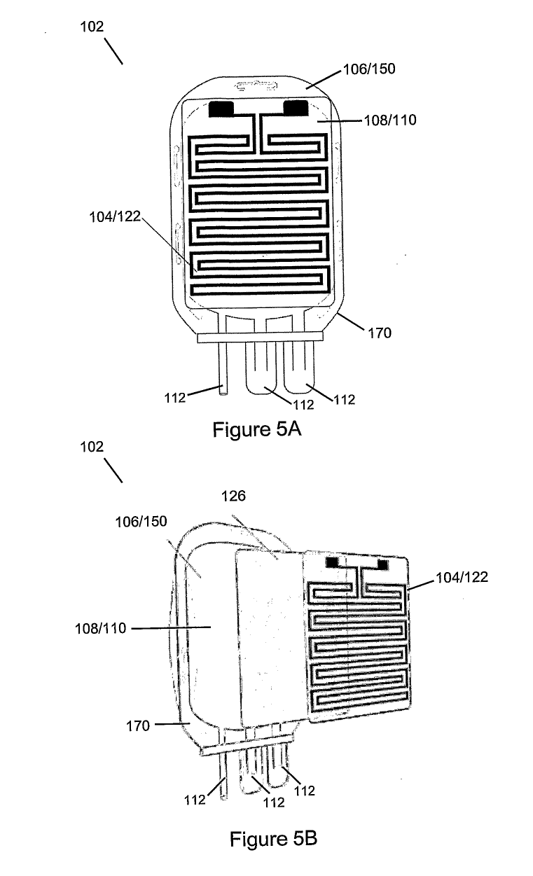

FIG. 5A shows a front view of a flexible fluid storage and warming bag 102 including an electrical heating layer arrangement 122 releasably attached to an exterior surface 150 of one flexible main wall 106 of the bag 102 according to an embodiment and FIG. 5B shows an exploded view of the flexible fluid storage and warming bag 102 as shown in FIG. 5A according to an embodiment.

The flexible fluid storage and warming bag 102 as shown in FIGS. 5A and 5B may be similar to the flexible fluid storage and warming bag 102 as shown in FIGS. 2A and 2B.

Like in FIGS. 2A and 2B, the flexible fluid storage and warming bag 102 as shown in FIGS. 5A and 5B may include two flexible main walls 106 (only one wall 106 is shown in FIG. 5A), each including a surrounding edge 170, the two flexible main walls 106 overlapping each other and being fluid-tightly sealed together along the surrounding edges 170 thereof. The bag 102 includes a single non-partitioned fluid chamber 110 defined by and between the two flexible main walls 106 and by the sealed surrounding edges 170. Further, the bag 102 includes three fluid transfer ports 112 extending into the single non-partitioned fluid chamber 110, each fluid transfer port 112 being configured to allow transfer of the fluid 108 into and out of the bag 102. In addition, the bag 102 includes an electrical heating element 104 integrated with one of the two flexible main walls 106 of the bag 102.

The three fluid transfer ports 112 may be a fluid inlet port, a fluid outlet port and a fluid transfer port or a spare port. FIGS. 5A and 5B show three fluid transfer ports 112 but there may be more or less than three fluid transfer ports 112 depending on user and design requirements.

Each electrical heating element 104 may include an electrical heating layer arrangement 122 attached to an exterior surface 150 of one of the two flexible main walls 106 of the bag 102. The electrical heating layer arrangement 122 may be configured to be flexible and made conformable to any fluid bag 102 surface so as to provide a flexible heating interface and an efficient heat transfer to the fluid 108 stored in the bag 102.

The electrical heating layer arrangement 122 may be releasably attached to the exterior surface 150 via an adhesive layer 126 or any other suitable means which allow temporary attachment and detachment of the electrical heating layer arrangement 122.

The electrical heating layer arrangement 122 may overlie at least substantially the entire exterior surface 150. The extent of overlay depends on the amount of fluid 108 housed within the bag 102 and the rate at which the fluid 108 needs to be warmed.

The electrical heating layer arrangement 122 may include a layer of an electrically conductive strip 124 employing a series circuitry heating and extending in a serpentine design. The electrically conductive strip 124 may include any suitable design as long as the electrically conductive strip 124 can generate distributed heat to warm up the fluid 108 stored inside the bag 102.

The layer of the electrically conductive strip 124 may be designed such that a surface ratio between the exterior surface 150 of either one of the two flexible main walls 106 and a total surface of the layer of the electrically conductive strip 124 attached to the exterior surface 150 of that one of the two flexible main walls 106 may be about 1:1.

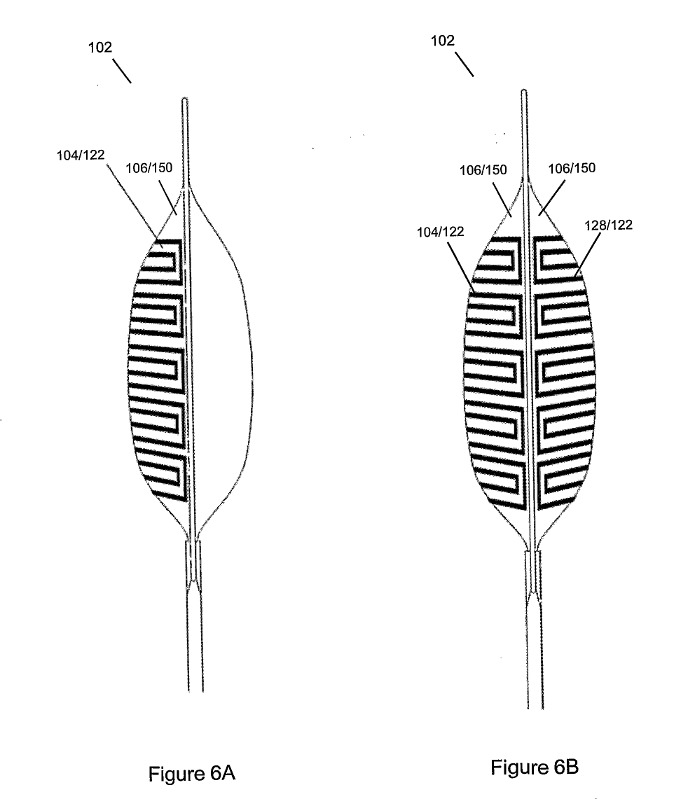

FIG. 6A shows a side view of a flexible fluid storage and warming bag 102 including an electrical heating element 104 integrated with one flexible main wall 106 of the bag 102 according to an embodiment and FIG. 6B shows a side view of a flexible fluid storage and warming bag 102 including an electrical heating element 104 integrated with one of the two flexible main walls 106 and a further electrical heating element 128 integrated with the other of the two flexible main walls 106 according to an embodiment.

In FIGS. 6A and 6B, each of the electrical heating element 104 and the further electrical heating element 128 may include a wire of a conductive material that generates resistance, when electrical current passes through it, and generates therefore heat, or a thermal conductive element disposed on the respective exterior surface 150 of the walls 106 of the bag 102. Alternatively, each of the electrical heating element 104 and the further electrical heating element 128 may be directly printed on the bag 102. In a further alternative, each of the electrical heating element 104 and the further electrical heating element 128 may include an electrical heating layer arrangement 122 attached to an exterior surface 150 of the respective one of the walls 106 of the bag 102.

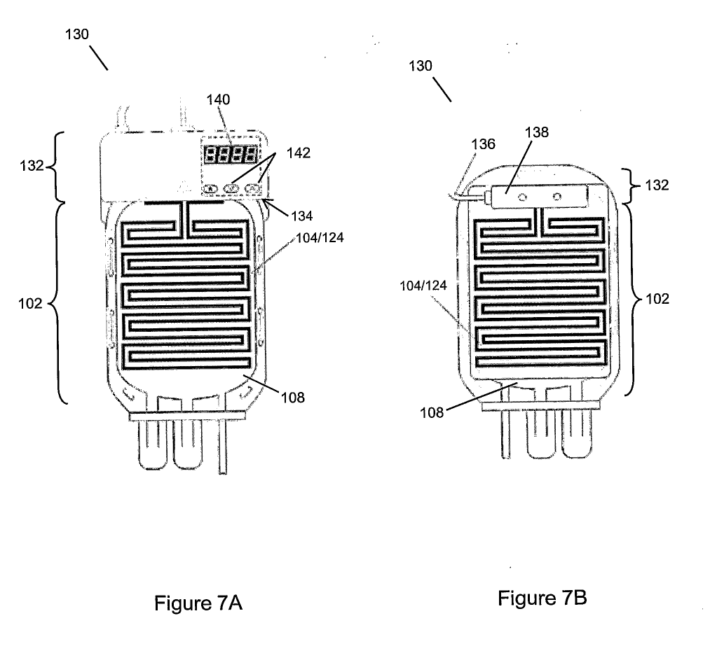

FIG. 7A shows a front view of a fluid storage and warming system 130 including a flexible fluid storage and warming bag 102 and a hanger and power supply device 132, wherein the hanger and power supply device 132 is electrically coupled to an electrical heating element 104 of the flexible fluid storage and warming bag 102 via a pair of hangers (hidden within the hanger and power supply device 132) and power supply contacts (hidden) according to an embodiment.

In FIG. 7A, the flexible fluid storage and warming bag 102 may be similar to that as shown in FIG. 1 or FIGS. 5A and 5B.

In FIG. 7A, the hanger and power supply device 132 may include a slot 134 so as to accommodate a portion of the flexible fluid storage and warming bag 102 there within. As an example when in use, the two end portions (not shown) of the electrically conductive strip 124 or the electrical heating element 104 may be positioned substantially within the slot 134.

The hanger and power supply device 132 may be electrically coupled to the electrical heating element 104 of the bag 102 to supply electrical power thereto. The hanger and power supply device 132 may be electrically coupled to the bag 102 by a pair of hangers and power supply contacts.

Further, the hanger and power supply device 132 may include a display 140 to display the temperature of the fluid 108 stored within the bag 102. The hanger and power supply device 132 also may include a temperature controller 142 so as to control the amount of power supplied to the electrical heating element 104 or electrically conductive strip 124 so as to increase or decrease the amount of heat supplied to the fluid 108 stored in the bag 102.

FIG. 7B shows a front view of a fluid storage and warming system 130 including a flexible fluid storage and warming bag 102 and a hanger and power supply device 132, wherein the hanger and power supply device 132 is electrically coupled to an electrical heating element 104 of the flexible fluid storage and warming bag 102 via an electrical wire 136 according to an embodiment. The difference between the fluid storage and warming system 130 as shown in FIG. 7A and the fluid storage and warming system 130 as shown in FIG. 7B is in the connection between the hanger and power supply device 132 and the electrical heating element 104 of the flexible fluid storage and warming bag 102.

The hanger and power supply device 132 may include a power supply contact 138. The hanger and power supply device 132 may be electrically coupled to the power supply contact 138, which may then be connected to the two end portions (covered by the power supply contact 138) of the electrically conductive strip 124 or the electrical heating element 104. This may provide an alternative method of coupling the hanger and power supply device 132 with the electrically conductive strip 124 or the electrical heating element 104.

In FIG. 7B, the flexible fluid storage and warming bag 102 may be the same as that as that as shown in FIG. 7A.

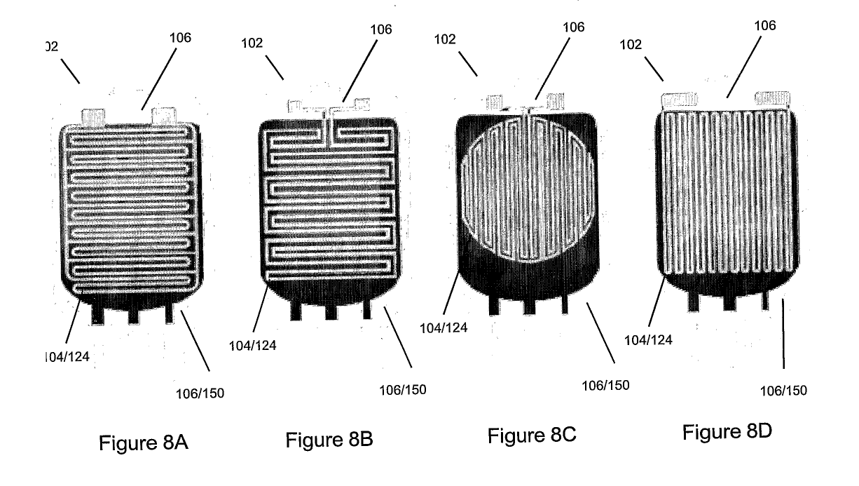

FIG. 8A shows a front view of a flexible fluid storage and warming bag 102 including an electrical heating element 104 with a first design integrated with one of the two flexible main walls 106 of the bag 102 according to an embodiment.

The electrical heating element 104 in FIG. 8A employs parallel circuitry heating (i.e. the electrically conductive strips 124 are connected in parallel). The electrical heating element 104 or the electrically conductive strip 124 may also be arranged in substantially rectangle pattern. The electrical heating element 104 or the electrically conductive strip 124 may be designed such that a surface ratio between the exterior surface 150 of either one of the two flexible main walls 106 and a total surface of the electrical heating element 104 or the electrically conductive strip 124 attached to the exterior surface 150 of that one of the two flexible main walls 106 may be about 1:1 for example. However, other ratios may also be possible depending on user and design requirements.

FIGS. 8B to 8D are different variations of electrical heating element designs employing series circuitry heating (i.e. the electrically conductive strips 124 are connected in series). FIG. 8B shows a front view of a flexible fluid storage and warming bag 102 including an electrical heating element 104 with a second design integrated with one of the two flexible main walls 106 of the bag 102 according to an embodiment.

Similar to FIG. 8A, the electrical heating element 104 or the electrically conductive strip 124 as shown in FIG. 8B may also be arranged in substantially rectangle pattern. The electrical heating element 104 or the electrically conductive strip 124 may be designed such that a surface ratio between the exterior surface 150 of either one of the two flexible main walls 106 and a total surface of the electrical heating element 104 or the electrically conductive strip 124 attached to the exterior surface 150 of that one of the two flexible main walls 106 may be about 1:1 for example. However, other ratios may also be possible depending on user and design requirements.

FIG. 8C shows a front view of a flexible fluid storage and warming bag 102 including an electrical heating element 104 with a third design integrated with one of the two flexible main walls 106 of the bag 102 according to an embodiment.

The electrical heating element 104 or the electrically conductive strip 124 may also be arranged in substantially circle pattern. The electrical heating element 104 or the electrically conductive strip 124 may be designed such that a surface ratio between the exterior surface 150 of either one of the two flexible main walls 106 and a total surface of the electrical heating element 104 or the electrically conductive strip 124 attached to the exterior surface 150 of that one of the two flexible main walls 106 may be about 1.5:1 for example. However, other ratios may also be possible depending on user and design requirements.

FIG. 8D shows a front view of a flexible fluid storage and warming bag 102 including an electrical heating element 104 with a fourth design integrated with one of the two flexible main walls 106 of the bag 102 according to an embodiment.

The electrical heating element 104 or the electrically conductive strip 124 may also be arranged in substantially rectangle pattern. The electrical heating element 104 or the electrically conductive strip 124 may be designed such that a surface ratio between the exterior surface 150 of either one of the two flexible main walls 106 and a total surface of the electrical heating element 104 or the electrically conductive strip 124 attached to the exterior surface 150 of that one of the two flexible main walls 106 may be about 1:1 for example. However, other ratios may be possible depending on user and design requirements.

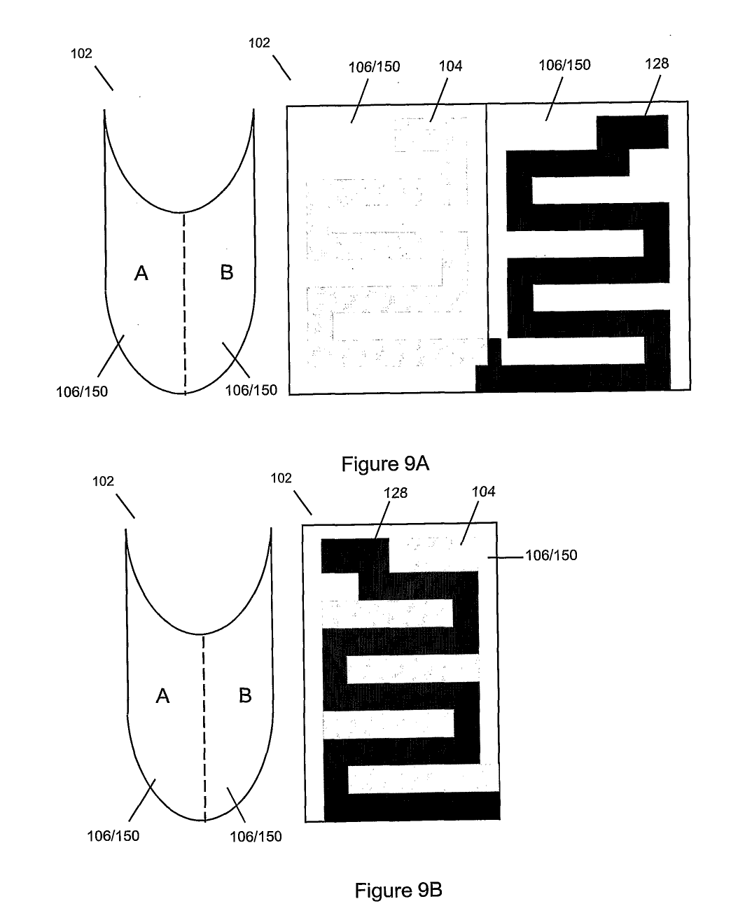

FIG. 9A shows an open-up view of a flexible fluid storage and warming bag 102, including an electrical heating element 104 integrated with one of the two flexible main walls 106 and a further electrical heating element 128 integrated with the other of the two flexible main walls 106 with at least substantially complementary designs according to an embodiment. FIG. 9B shows an overlapping view of the flexible fluid storage and warming bag 102 as shown in FIG. 9A according to an embodiment.

In FIGS. 9A and 9B, each of the electrical heating element 104 and the further electrical heating element 128 may include a wire or a thermal conductive element disposed on the respective exterior surface 150 of the walls 106 of the bag 102. Alternatively, each of the electrical heating element 104 and the further electrical heating element 128 may be directly printed on the bag 102. The electrical heating element 104 integrated with one of the two flexible main walls 106 and the further electrical heating element 128 integrated with the other of the two flexible main walls 106 are of at least substantially complementary designs. The electrical heating element 104 and the further electrical heating element 128 may be configured such that a large overlapping area may be covered when the two flexible main walls 106 overlap with each other.

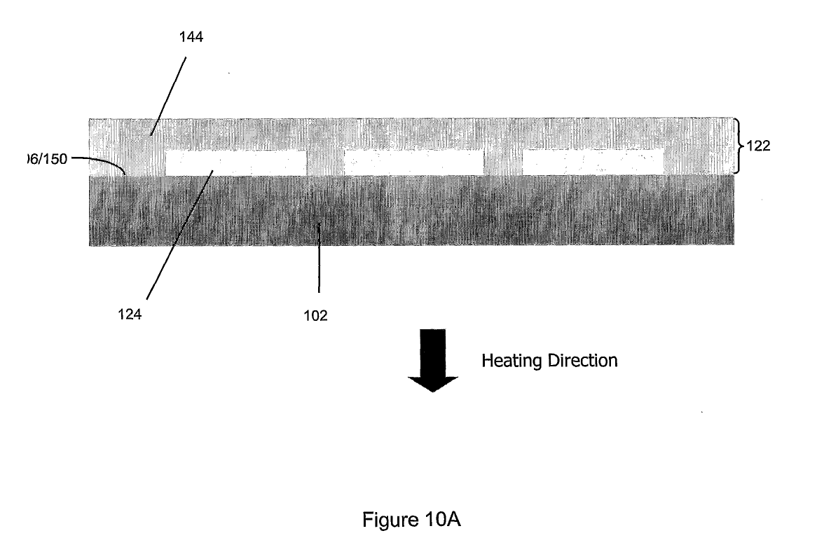

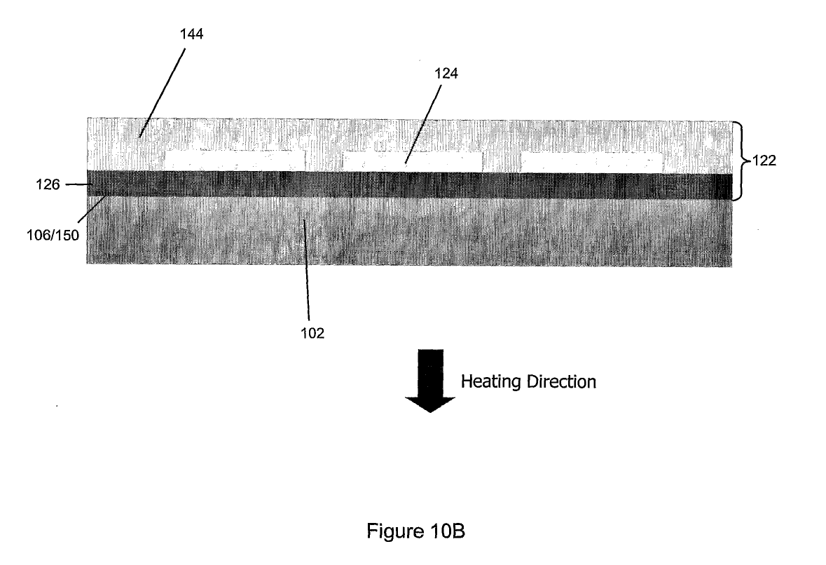

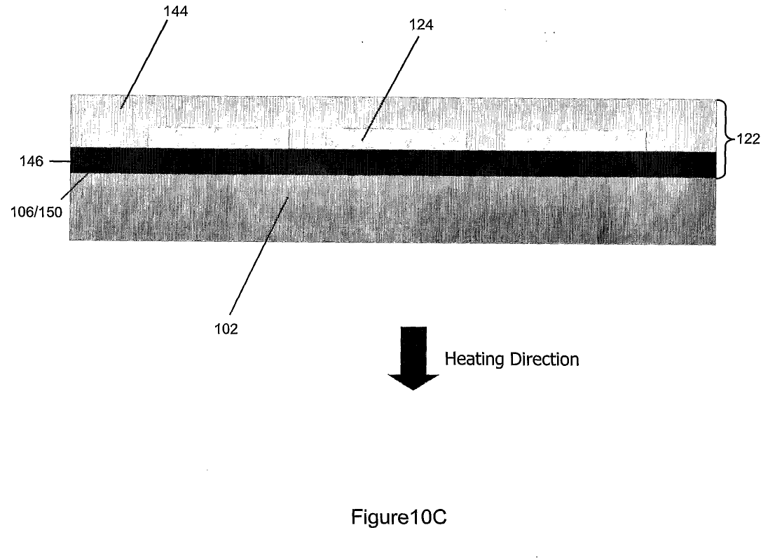

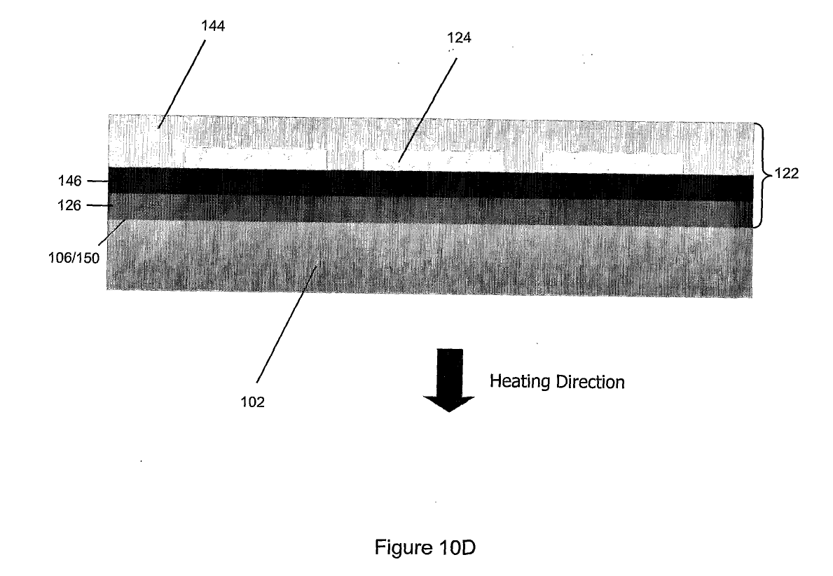

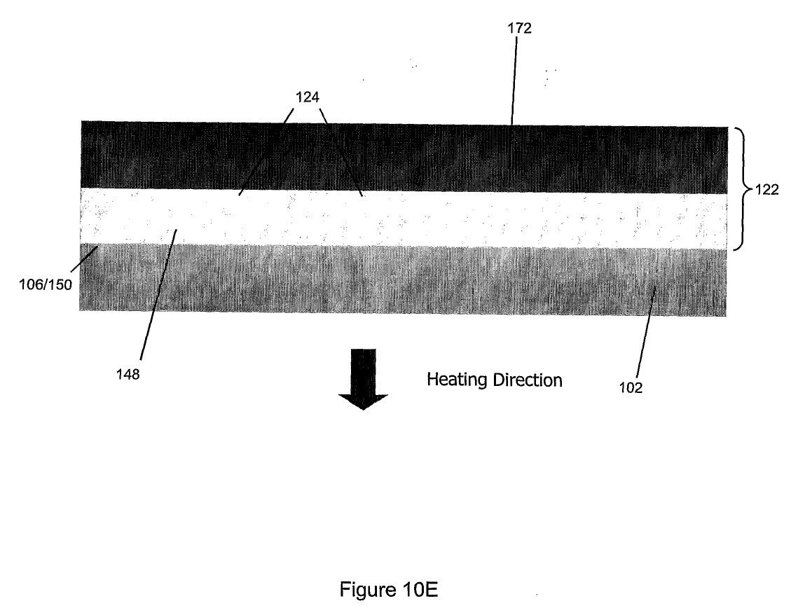

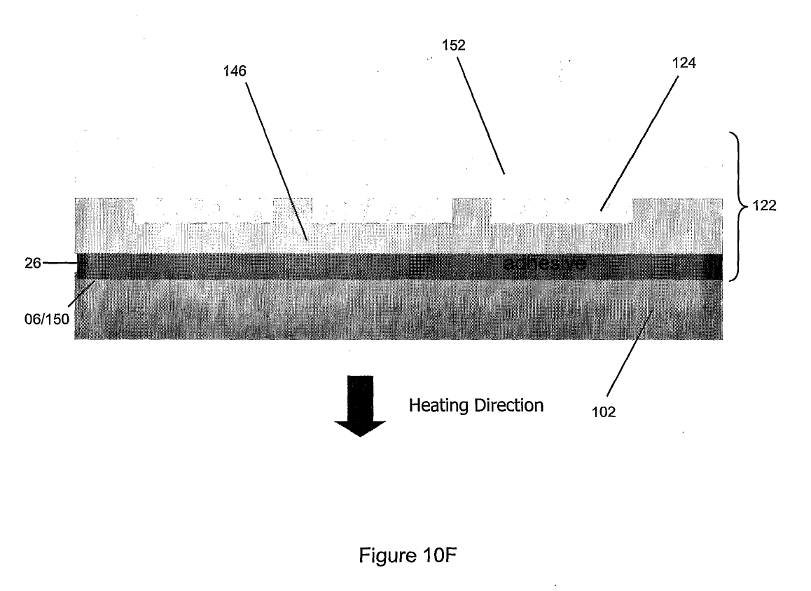

FIGS. 10A to 10F show respective electrical heating layer arrangements 122 including different layers attached on a flexible fluid storage and warming bag 102 according to an embodiment.

FIG. 10A shows an electrical heating layer arrangement 122 attached on a flexible fluid storage and warming bag 102. The direction of the heat from the electrically conductive strip 124 onto the bag 102 may be as shown by the arrow. The electrical heating layer arrangement 122 includes a layer of electrically conductive strip 124 attached on an exterior surface 150 of one of the two flexible main walls 106 of the bag 102. The layer of the electrically conductive strip 124 may be printed directly on the exterior surface 150 of one of the two flexible main walls 106 of the bag 102 or may be deposited or disposed on the exterior surface 150 of one of the two flexible main walls 106 of the bag 102 by other suitable means. The layer of the electrically conductive strip 124 may include a material selected from a group consisting of a silver-based conductive ink, copper-based conductive ink, conductive polymer ink, and carbon-based resistive ink for example.

The electrical heating layer arrangement 122 may further include a thermal insulation and electrical insulation layer 144 arranged in contact with the layer of the electrically conductive strip 124 and the exterior surface 150 of one of the two flexible main walls 106 of the bag 102.

FIG. 10B shows an electrical heating layer arrangement 122 attached on a flexible fluid storage and warming bag 102. The electrical heating layer arrangement 122 as shown in FIG. 10B may be similar to the electrical heating layer arrangement 122 as shown in FIG. 10A except that the electrical heating layer arrangement 122 as shown in FIG. 10B includes an adhesive layer 126 arranged between the exterior surface 150 and the layer of the electrically conductive strip 124. The layer of the electrically conductive strip 124 may first be disposed on the adhesive layer 126 before the adhesive layer 126 is brought to be in contact with the exterior surface 150 of one of the two flexible main walls 106 of the bag 102.

FIG. 10C shows an electrical heating layer arrangement 122 attached on a flexible fluid storage and warming bag 102. The electrical heating layer arrangement 122 as shown in FIG. 10C may be similar to the electrical heating layer arrangement 122 as shown in FIG. 10A except that the electrical heating layer arrangement 122 as shown in FIG. 10C includes a thermal diffusion layer 146 arranged between the exterior surface 150 of one of the two flexible main walls 106 of the bag 102 and the layer of the electrically conductive strip 124.

The thermal diffusion layer 146 may provide a thermally efficient path from the layer of the electrically conductive strip 124 to the fluid 108 stored in the bag 102 to be heated. Further, the thermal diffusion layer 146 may provide a substantially uniform thermal heating of the fluid 108 stored within the bag 102.

FIG. 10D shows an electrical heating layer arrangement 122 attached on a flexible fluid storage and warming bag 102. The electrical heating layer arrangement 122 as shown in FIG. 10D may be similar to the electrical heating layer arrangement 122 as shown in FIG. 10C except that the electrical heating layer arrangement 122 as shown in FIG. 10D includes an adhesive layer 126 arranged between the exterior surface 150 of one of the two flexible main walls 106 of the bag 102 and the thermal diffusion layer 146.

FIG. 10E shows an electrical heating layer arrangement 122 attached on a flexible fluid storage and warming bag 102. The electrical heating layer arrangement 122 as shown in may include a thermal conduction and electrical insulation layer 148 arranged in contact with the exterior surface 150 of one of the two flexible main walls 106 of the bag 102 and the layer of the electrically conductive strip 124 arranged on the thermal conduction and electrical insulation layer 148. The electrical heating layer arrangement 122 may further include a thermal insulation layer 172 arranged on a side of the layer of the electrically conductive strip 124 being remote from the exterior surface 150 of one of the two flexible main walls 106 of the bag 102 to which the electrical heating layer arrangement 122 is attached. The thermal insulation layer 172 may include a material selected from a group consisting of a thermally insulating epoxy, a thermally insulating adhesive, and a thermally insulating resin, for example.

FIG. 10F shows an electrical heating layer arrangement 122 attached on a flexible fluid storage and warming bag 102. The electrical heating layer arrangement 122 may include an adhesive layer 126 arranged on the exterior surface 150 of one of the two flexible main walls 106 of the bag 102, a thermal diffusion layer 146 arranged on the adhesive layer 126 and the layer of electrically conductive strip 124 arranged on the thermal diffusion layer 146.

The electrical heating layer arrangement 122 may further include a base layer 152 arranged on a side of the layer of the electrically conductive strip 124 being remote from the exterior surface 150 of one of the two flexible main walls 106 of the bag 102 to which the electrical heating layer arrangement 122 is attached. The base layer 152 may include a material selected from a group consisting of a polyethylene terephthalate (PET) substrate, and a polyethylene naphthalate (PEN) substrate, for example. The base layer 152 may be of a relatively rigid material so as to act as a base for subsequent deposition of materials.

As an example, the base layer 152 may act as a starting layer for deposition of the layer of the electrically conductive strip 124, the thermal diffusion layer 146 and the adhesive layer 126 before the adhesive layer 126 may be brought into contact with the exterior surface 150 of the one of the two flexible main walls 106 of the bag 102. The base layer 152 may be removed after the electrical heating layer arrangement 122 may be brought into contact with the exterior surface 150. Alternatively, the base layer 152 may remain as an exterior layer of the electrical heating layer arrangement 122 so as to prevent direct exposure of the layer of electrically conductive strip 124 to the user.

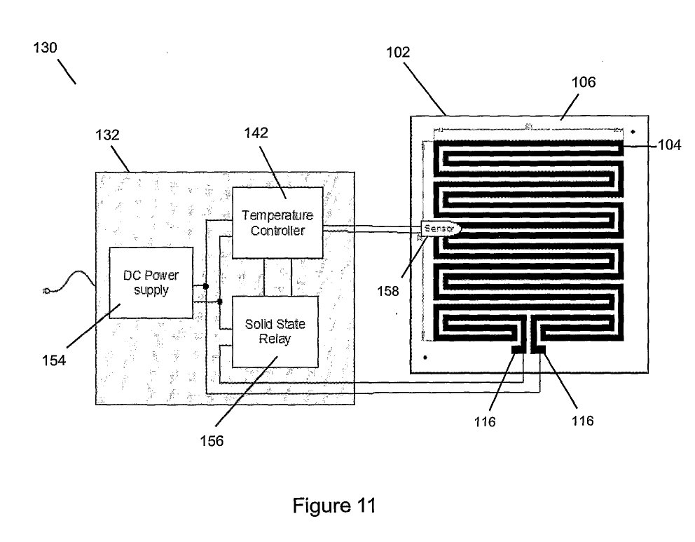

FIG. 11 shows a block diagram of a fluid storage and warming system 130 including a flexible fluid storage and warming bag 102 and a hanger and power supply device 132 according to an embodiment.

The flexible storage and warming bag 102 may include an electrical heating element 104 integrated with one of the two flexible main walls 106 of the bag 102. The electrical heating element 104 may include two end portions 116 configured for connection to the hanger and power supply device 132.

The hanger and power supply device 132 may include a power supply unit 154, a temperature controller 142, a solid state relay 156 and a temperature sensor 158. The power supply unit 154 may include a battery. For example, the power supply unit 154 may be a lithium polymer battery configured to yield an overall voltage of about 12 Vdc to about 15 Vdc rated at 3 amp-hour (Ah) or a normal AC-DC adapter yielding preferably about 30 W rating. In the absence of the power supply unit 154, the power may be supplied directly from the supply mains. The temperature controller 142 may be adapted to control the power delivered to the electrical heating element 104 so as to control the amount of heat being supplied to the fluid (not shown) stored in the bag 102. The solid state relay 156 is an electronic on-off switch to regulate the voltage output of the hanger and power supply device 132. The solid state relay 156 may include a relay with a control voltage of between about 3 VDC to about 32 VDC and a load voltage of about 3 VDC to about 36 VDC. The current is about 3 A. The temperature sensor 158 may be positioned close to the bag 102 so as to measure temperature of the fluid stored within the bag 102.

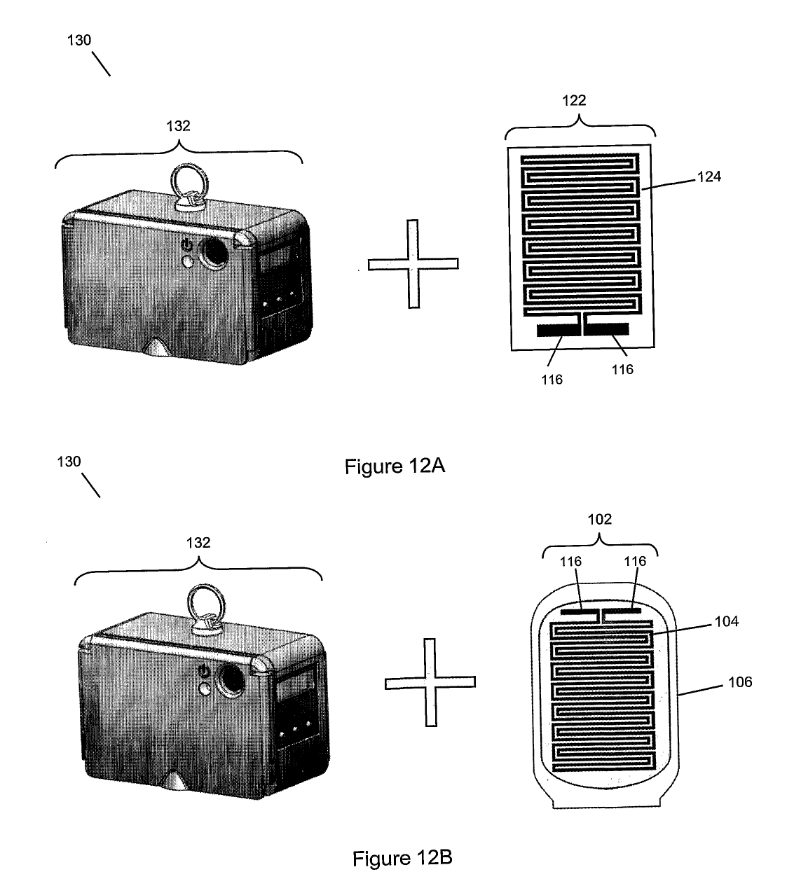

FIG. 12A shows a fluid storage and warming system 130 including an electrical heating layer arrangement 122 and a hanger and power supply device 132 according to an embodiment. The electrical heating layer arrangement 122 includes a layer of an electrically conductive strip 124 and the electrically conductive strip 124 includes two end portions 116 configured for connection to the hanger and power supply device 132.

FIG. 12B shows a fluid storage and warming system 130 including a flexible fluid storage and warming bag 102 and a hanger and power supply device 132 according to an embodiment. The flexible storage and warming bag 102 may include an electrical heating element 104 integrated with one of the two flexible main walls 106 of the bag 102. The electrical heating element 104 may be disposed or printed directly on one of the two flexible main walls 106 of the bag 102. The electrical heating element 104 may include two end portions 116 configured for connection to the hanger and power supply device 132.

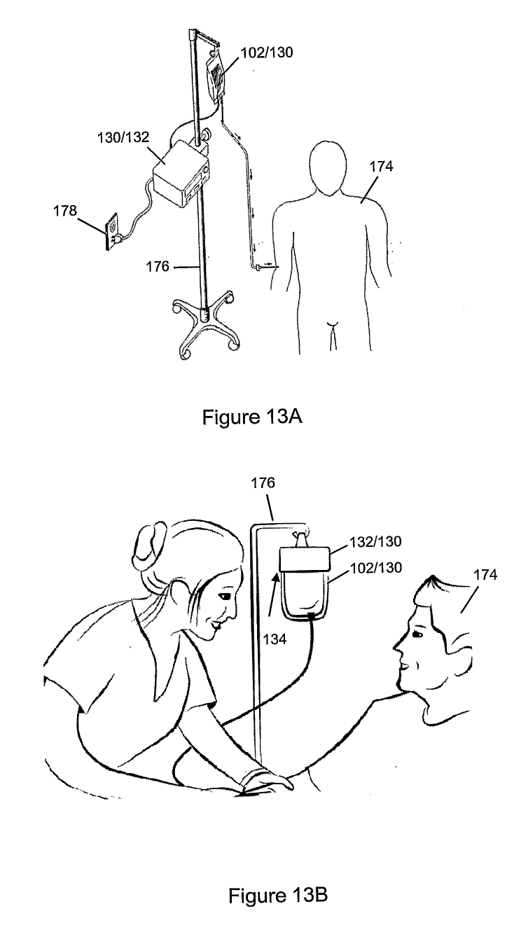

FIG. 13A shows the fluid storage and warming system 130 of FIG. 7B in use on a patient 174 according to an embodiment. In FIG. 13A, the bag 102 is being hanged onto a portion of a stand 176 and the hanger and power supply device 132 is being hanged onto a further portion of the stand 176. Further, the hanger and power supply device 132 is being shown to be connected to a supply mains 178.

FIG. 13B shows the fluid storage and warming system 130 of FIG. 7A in use on a patient 174 according to an embodiment. In FIG. 13B, the bag 102 is connected and housed within a slot 134 in the hanger and power supply device 132. Both the bag 102 and the hanger and power supply device 132 are being hanged onto a same portion of a stand 176. Further, the hanger and power supply device 132 is not shown to be connected to a supply mains (not shown) as the hanger and power supply device 132 may include a rechargeable battery housed within. The rechargeable battery may be configured to supply power to the electrical heating element. Therefore, the fluid storage and warming system 130 may be portable.

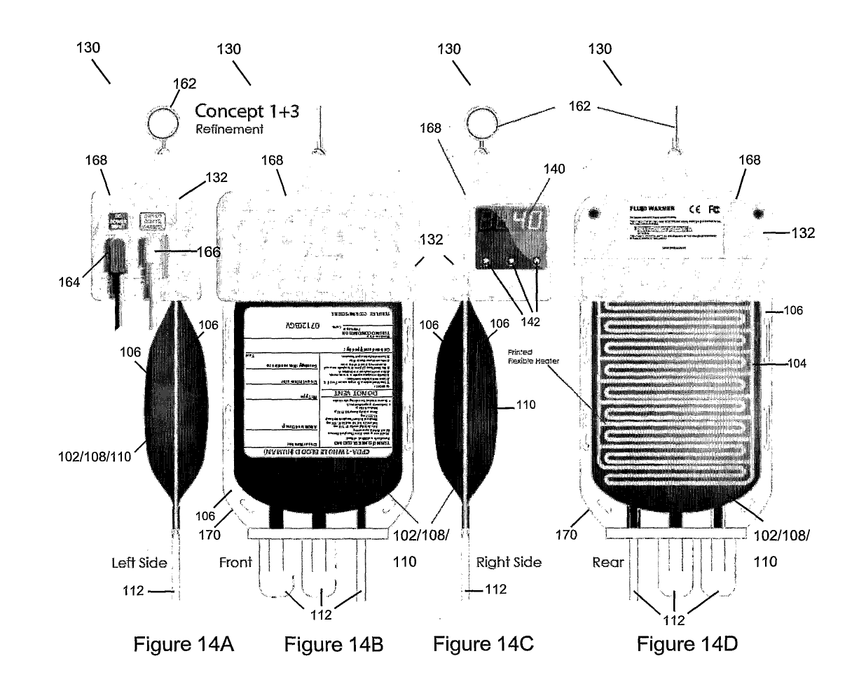

FIG. 14A shows a left side view of the fluid storage and warming system 130 including a flexible fluid storage and warming bag 102 and a hanger and power supply device 132, wherein the hanger and power supply device 132 is electrically coupled to an electrical heating element 104 of the flexible fluid storage and warming bag 102 via a pair of hangers (not shown) and power supply contacts (not shown) according to an embodiment. FIG. 14B shows a front view of the fluid storage and warming system 130 as shown in FIG. 14A according to an embodiment; FIG. 14C shows a right side view of the fluid storage and warming system 130 as shown in FIG. 14A according to an embodiment; FIG. 14D shows a rear view of the fluid storage and warming system 130 as shown in FIG. 14A according to an embodiment.

In FIGS. 14A to 14D, the fluid storage and warming system 130 is shown to include a flexible fluid storage and warming bag 102 and a hanger and power supply device 132 adapted to be electrically coupled to the electrical heating element 104 of the bag 102 to supply electrical power thereto.

The flexible fluid storage and warming bag 102 may include two flexible main walls 106, each including a surrounding edge 170, the two flexible main walls 106 overlapping each other and being fluid-tightly sealed together along the surrounding edges 170 thereof, the bag 102 including a single non-partitioned fluid chamber 110 defined by and between the two flexible main walls 106 and by the sealed surrounding edges 170; three fluid transfer ports 112 extending into the single non-partitioned fluid chamber 110 and being configured to allow transfer of the fluid 108 into and out of the bag 102; and an electrical heating element 104 integrated with one of the two flexible main walls 106 of the bag 102.

The hanger and power supply device 132 may include any suitable combination of components selected from a group consisting of a power supply (not shown), a temperature controller 142, a solid state relay (not shown), a display 140 to display temperature of the fluid 108 stored within the bag 102, a power supply input port 164, a power supply output port 166, a temperature sensor (not shown), and a power supply switch (not shown) housed within a casing 168 or an enclosure. The hanger and power supply device 132 may include a swivel ring 162 configured to allow the hanger and power supply device 132 to be positioned rotatably on a stand (not shown). The swivel ring 162 may be of any suitable dimension and shape.

From the left side view as shown in FIG. 14A, the hanger and power supply device 132 is seen to include the power supply input port 164 and the power supply output port 166. Power from a supply mains may be supplied to the power supply input port 164.

From the right side view as shown in FIG. 14C, the hanger and power supply device 132 is seen to include the temperature controller 142 to control the amount of power supplied to the electrical heating element 104 so as to increase or decrease the heat supplied to the fluid 108 stored within the bag 102. The hanger and power supply device 132 may also be seen to include the display 140 to display temperature of the fluid 108 stored within the bag 102.

From the rear view as shown in FIG. 14D, the fluid storage and warming bag 102 is seen to include the electrical heating element 104 integrated with one of the two flexible main walls 106 of the bag 102.

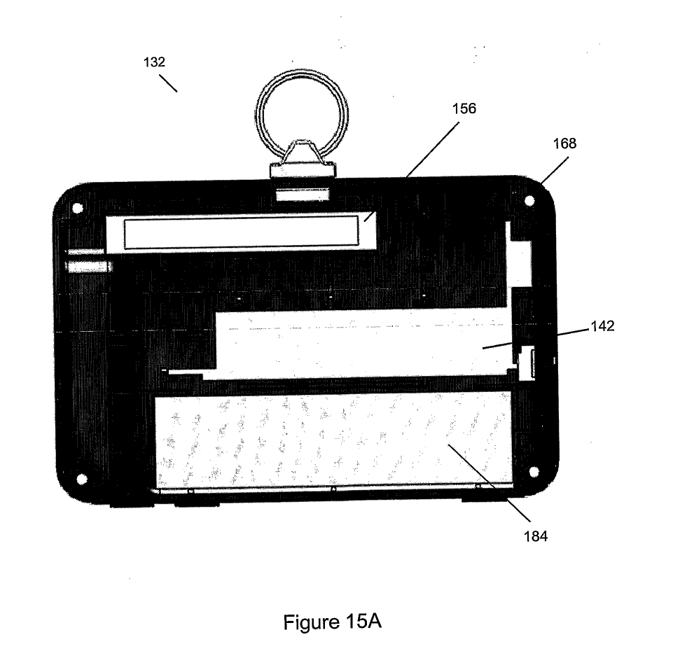

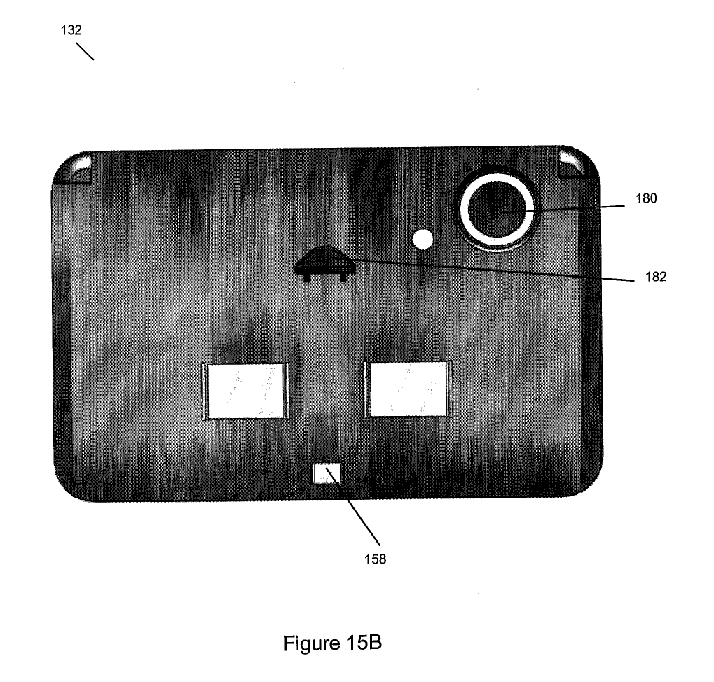

FIG. 15A shows an internal view of the hanger and power supply device 132 as shown in FIGS. 14A to 14D according to an embodiment.

From the internal view as shown in FIG. 15A, the hanger and power supply device 132 includes a battery 184, a temperature controller 142 and a solid state relay 156 housed within a casing 168.

FIG. 15B shows a front open-up view of the hanger and power supply device 132 as shown in FIGS. 14A to 14D according to an embodiment. From the front open-up view as shown in FIG. 15B, the hanger and power supply device 132 includes a power switch 180 to turn on the electrical heating element (not shown), a hanger or hook 182 for hanging the bag (not shown) on the hanger and power supply device 132 and a temperature sensor 158 for sensing the temperature of the fluid (not shown) stored in the bag (not shown).

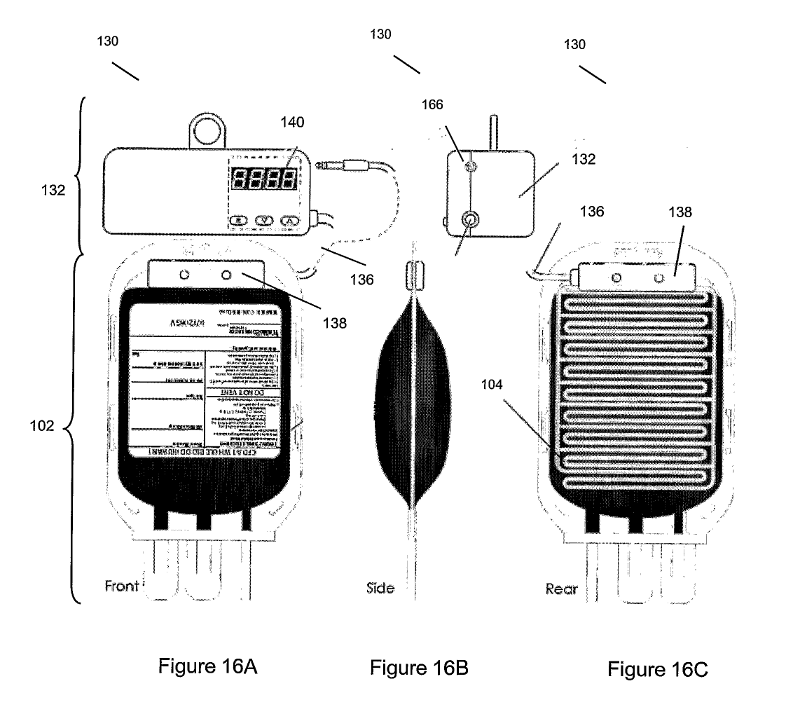

FIG. 16A shows a front view of the fluid storage and warming system 130 including a flexible fluid storage and warming bag 102 and a hanger and power supply device 132, wherein the hanger and power supply device 132 is electrically coupled to an electrical heating element 104 on the flexible fluid storage and warming bag 102 via an electrical wire 136 according to an embodiment; FIG. 16B shows a side view of the fluid storage and warming system 130 as shown in FIG. 16A according to an embodiment and FIG. 16C shows a rear side view of the fluid storage and warming system 130 as shown in FIG. 16A according to an embodiment.

The fluid storage and warming system 130 as shown in FIGS. 16A to 16C may be similar to the fluid storage and warming system 130 as shown in FIGS. 14A to 14D with the difference in the method of connection between the hanger and power supply device 132 and the bag 102. Further, there is a difference in the positioning of the display 140 on the hanger and power supply device 132. The display 140 is seen from the right side view as shown in FIG. 14C, while the display 140 is seen in the front view in FIG. 16A.

In FIGS. 16A to 16C, a power supply contact 138 may be coupled to the end portions (not shown) of the electrical heating element 104 on the bag 102. Then, the power supply contact 138 may be coupled by the electrical wire 136 or a blood bag power cord to a power supply output port 166 on the hanger and power supply device 132. Further, the hanger and power supply device 132 may include a power supply input port 164, configured to allow connection to a supply mains. The position of the respective power supply input port 164 and the power supply output port 166 may vary depending on the positioning of the respective electronics components housed within the hanger and power supply device 132.

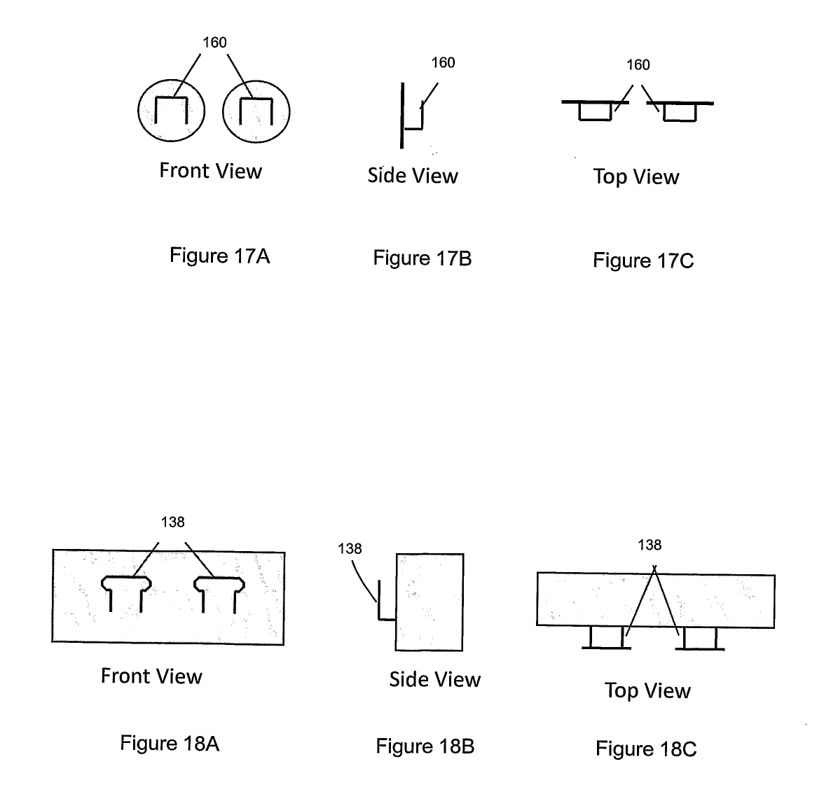

FIG. 17A show a front view of a pair of hangers 160 of a flexible fluid storage and warming bag (not shown) according to an embodiment; FIG. 17B show a side view of the pair of hangers 160 as shown in FIG. 17A according to an embodiment; FIG. 17C show a top view of the pair of hangers 160 as shown in FIG. 17A according to an embodiment.

Each of the pair of hangers 160 is of an electrically conductive material and attached to a respective one of the two end portions (not shown) of the electrically conductive strip (not shown) so as to be electrically connected thereto. Further, each of the pair of hangers 160 is adapted to be mechanically engaged with and electrically coupled to the hanger and power supply device (not shown).

FIG. 18A show a front view of a pair of power supply contacts 138 of a hanger and power supply device (not shown) according to an embodiment; FIG. 18B show a side view of the pair of power supply contacts 138 as shown in FIG. 18A according to an embodiment; FIG. 18C show a top view of the pair of power supply contacts 138 as shown in FIG. 18A according to an embodiment. The pair or two power supply contacts 138 as shown in FIGS. 18A to 18C are configured to be respectively mechanically engaged with and electrically connected to the pair or two hangers 160 as shown in FIGS. 17A to 17C. Further, the pair of power supply contacts 138 are configured to be complementary to the pair of hangers 160 so that it may facilitate the ease of coupling the bag (not shown) to the hanger and power supply device (not shown) and so that the electrical connection may be established via the respective power supply contacts 138 and the hangers 160. The dimensions and shape of the respective hangers 160 and the power supply contacts 138 may vary depending on user and design requirements.

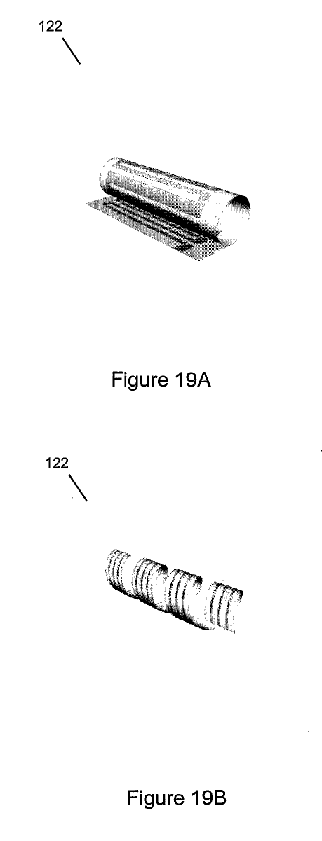

FIG. 19A shows a perspective view of an electrical heating layer arrangement 122 configured to coil around a tubing (not shown) according to an embodiment; FIG. 19B shows a perspective view of an electrical heating layer arrangement 122 configured to twirl around a tubing (not shown) according to an embodiment.

The electrical heating layer arrangement 122 as shown in FIGS. 19A and 19B includes a layer of electrically conductive strip 124. The electrical heating layer arrangement 122 is made to be flexible so as to be able to at least substantially surround the tubing so as to warm the fluid (not shown) flowing through the tubing.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A flexible fluid storage and warming bag for storing and warming of fluid before fluid transfer comprising:
two flexible main walls, each including a surrounding edge, the two flexible main walls overlapping each other and being fluid-tightly sealed together along the surrounding edges thereof, the bag including a single non-partitioned fluid chamber defined by and between the two flexible main walls and by the sealed surrounding edges;
at least one fluid transfer port extending into the single non-partitioned fluid chamber and being configured to allow transfer of the fluid into and out of the bag; and
an electrical heating element integrated with at least one of the two flexible main walls of the bag.

2. The flexible fluid storage and warming bag according to claim 1, further comprising a further electrical heating element,
wherein the electrical heating element is integrated with one of the two flexible main walls of the bag and the further electrical heating element is integrated with the other of the two flexible main walls of the bag.

3. The flexible fluid storage and warming bag according to claim 1,
wherein each electrical heating element comprises an electrical heating layer arrangement attached to an exterior surface of the respective one of the two flexible main walls of the bag.

4. The flexible fluid storage and warming bag according to claim 3,
wherein the electrical heating layer arrangement is releasably attached to the exterior surface.

5. The flexible fluid storage and warming bag according to claim 3,
wherein the electrical heating layer arrangement is attached to the exterior surface by a technique selected from a group consisting of printing, embossing, heat sealing, sonic sealing, adhesion, lithographic and a combination thereof.

6. The flexible fluid storage and warming bag according to claim 3,
wherein the electrical heating layer arrangement overlies at least substantially the entire exterior surface.

7. The flexible fluid storage and warming bag according to claim 3,
wherein the electrical heating layer arrangement comprises a layer of an electrically conductive strip extending in one of a meander design, a serpentine design and a spiral design on the exterior surface.

8. The flexible fluid storage and warming bag according to claim 7,
wherein the layer of the electrically conductive strip attached to the exterior surface of the one of the two flexible main walls and the layer of the electrically conductive strip attached to the exterior surface of the other of the two flexible main walls are of at least substantially complementary designs.

9. The flexible fluid storage and warming bag according to claim 7,
wherein the layer of the electrically conductive strip is designed such that a surface ratio between the exterior surface of either one of the two flexible main walls and a total surface of the layer of the electrically conductive strip attached to the exterior surface of that one of the two flexible main walls is between 3:1 and 1.5:1.

10. The flexible fluid storage and warming bag according to claim 7,
wherein the layer of the electrically conductive strip comprises a material selected from the group consisting of silver-based conductive ink, copper-based conductive ink, conductive polymer ink, and carbon-based resistive ink.

11. The flexible fluid storage and warming bag according to claim 7, wherein the electrical heating layer arrangement further comprises an adhesive layer arranged between the exterior surface and the layer of the electrically conductive strip.

12. The flexible fluid storage and warming bag according to claim 7,
wherein the electrical heating layer arrangement further comprises a thermal diffusion layer arranged between the exterior surface and the layer of the electrically conductive strip.

13. The flexible fluid storage and warming bag according to claim 7, wherein the electrical heating layer arrangement further comprises a thermal diffusion layer arranged on the layer of the electrically conductive strip and an adhesive layer arranged between the exterior surface and the thermal diffusion layer.

14. The flexible fluid storage and warming bag according to claim 11,
wherein the adhesive layer comprises a material selected from a group consisting of heat curing adhesive layers, UV curing adhesive layers, and pressure sensitive adhesive layers.

15. (canceled)

16. The flexible fluid storage and warming bag according to claim 7, wherein the electrical heating layer arrangement further comprises a thermal insulation layer arranged on a side of the layer of the electrically conductive strip being remote from the exterior surface of the main wall of the bag to which the electrical heating layer arrangement is attached.

17. (canceled)

18. The flexible fluid storage and warming bag according to claim 7, further comprising:
two longitudinal sides and two transverse sides along the surrounding edges of the two flexible main walls, wherein the electrically conductive strip includes two end portions being arranged proximate to one of the two transverse sides of the bag.

19. The flexible fluid storage and warming bag according to claim 18,
wherein each end portion is designed to include a larger width than that of the electrically conductive strip and to be contacted to an external power supply.

20. The flexible fluid storage and warming bag according to claim 18, further comprising:
a pair of hangers for hanging the bag on a hanger and power supply device,
wherein each of the pair of hangers is of an electrically conductive material and attached to a respective one of the two end portions of the electrically conductive strip so as to be electrically connected thereto.

21. The flexible fluid storage and warming bag according to claim 20,
wherein each of the pair of hangers is adapted to be mechanically engaged with and electrically coupled to the hanger and power supply device.

22. A fluid storage and warming system comprising
a flexible fluid storage and warming bag according to claim 1, and
a hanger and power supply device adapted to be electrically coupled to the electrical heating element of the bag to supply electrical power thereto.

23. (canceled)
